(19) United States
(12) Patent Application Publication
(10) Pub. No.: US 2014/0208263 A1
(43) Pub. Date: Jul. 24, 2014

(54) SYSTEM AND METHOD FOR DYNAMICALLY DISPLAYING CHARACTERS OVER A SCREEN OF A COMPUTERIZED MOBILE DEVICE

(71) Applicant: Victor Maklouf, Herzliya (IL)

(72) Inventor: Victor Maklouf, Herzliya (IL)

(21) Appl. No.: 13/962,873

(22) Filed: Aug. 8, 2013

Related U.S. Application Data
(60) Provisional application No. 61/756,090, filed on Jan. 24, 2013.

(51) Int. Cl. G06T 15/20

(52) U.S. Cl. CPC G06T 15/20
USPC 715/802

(57) ABSTRACT

A method of changing a display of an original image on a screen of a computerized mobile device is provided herein. The method comprises the following steps: (i) dynamically identifying conditions related to display changes. The identified conditions are as a result of an identified event; (ii) dynamically selecting at least one area of the original image that is displayed on the screen that is defined as an Area of interest (AOI), according to the identified conditions; and (iii) dynamically changing the display of the original image according to the AOI by visually enhancing said AOI area such that the visual enhancement gradually decreases from the AOI and farther thereto, to visually emphasize the AOI area while maintaining visual continuity of the entire original image. The visual continuity in each area of visual enhancement in the original image is maintained by a convex visual effect.

### TECHNICAL FIELD

The present invention relates to the field of screen display for a computerized mobile device, and more particularly to change of mode of representation on a screen of a computerized mobile device.

### BACKGROUND

In the known art there are techniques for increasing the displayable font size while retaining a wide text line of information on small information displays. In one embodiment, the inventive technique leverages the wider diagonal (in device dimensions) for text viewing and combine this form of display with a horizontal (in text dimensions) scrolling feature i.e. scrolling text along the diagonal of the device's display. Vertical context (in text dimensions) is maintained by adding a constant-offset look-ahead and look-back line above the primary diagonal focus area. Another embodiment bends the text along two edges of the display area to leverage the fact that the lengths of the two sides are even longer than the length of the screen diagonal. In both configurations, one can retain a large font size without sacrificing the number of characters displayed per line.

Additionally, in the known art there are an apparatus, method and computer program product which are provided for using dual side input devices for controlling an electronic device and applications running thereon. According to one technique, a user take some action with respect to an adjustable feature associated with the electronic device (e.g., zoom and/or skew an image on a display screen) by simulating (or actually) bending or twisting the electronic device. According to another technique, the user may cause a region of an image displayed on the front of the device to be magnified by touching the back of the device at a location that corresponds to the region. According to yet another technique, the user may cause a graphical item displayed on the front of the electronic device to be rotated by essentially simulating the grabbing of the item with two or more fingers on either side of the electronic device and rolling the item.

### SUMMARY

According to some embodiments of the invention, a method of changing a display of an original image on a screen of a computerized mobile device is provided herein. The method is comprising the following steps: (i) dynamically identifying conditions related to display changes, wherein the identified conditions are as a result of an identified event; (ii) dynamically selecting at least one area of the original image that is displayed on the screen that is defined as an area Of Interest (ZOI), according to the identified conditions; and (iii) dynamically changing the display of the original image according to the AOI by visually enhancing said AOI area such that the visual enhancement gradually decreases from the AOI and farther thereto, to visually emphasize the AOI area while maintaining visual continuity of the entire original image. The visual continuity in each area of visual enhancement in the original image is maintained by a convex visual effect, and the visual enhancement comprises enlargement of details in the AOI area.

According to some embodiments of the invention, the visual continuity in each area of visual enhancement in the original image is maintained by a polygonal visual effect.

According to some embodiments of the invention, a method of changing a display of an original image on a screen of a computerized mobile device is provided herein The method comprising the steps of: selecting of an area of interest over the screen according to presentation conditions, dynamically changing presentation of the characters over the screen by creating a curving optical visual effect thereof, over the selected area of interest according to the presentation conditions, said curving visual effect includes visually enhancing the characters around a focal area, which is a selected part of the area of interest, and gradually reducing the enhancement visual effect in a continuous manner farther from the selected focal area, said enhancement includes at least one of the following: enlarging of the characters font size, adding characters, enlarging space between characters, or creating a focus effect at the focal area; and dynamically changing the position of the focal area inside the area of interest according to data from said at least one sensor based on predefined rules, wherein the visual enhancement creates a 3D visual effect in which the characters appear to be deployed over a curved surface and the selection of the area of interest, changing of the characters presentation, dynamically changing the focal area of the visual effect are carried out by at least one processor.

According to some embodiments of the invention, the visual enhancement includes: (i) change of resolution; and (ii) change of image sharpness.

According to some embodiments of the invention, the convex visual effect enables display of a larger amount of data compared to the original image.

According to some embodiments of the invention, the identified area is text, and wherein the dynamically changing of the display of the original image according to the AOI by visually enhancing said AOI area is by changing letter-spacing within text and text font width.

According to some embodiments of the invention, the method further includes scrolling the area of visual enhancement in the original image horizontally or vertically across the screen of the computerized mobile device according to a change in the selected partial area displayed on the screen, thereby enabling a user to view a different portion of the original image.

According to some embodiments of the invention, the identified event is user's behavior and wherein the selecting of the partial area is performed by monitoring user's behavior.

According to some embodiments of the invention, user's behavior is identified by a calculation of a combination of: (i) tilting of the computerized mobile device; and (ii) head movement, wherein a gyroscope sensor is measuring the tilting, and wherein a camera is recording images of a head of the user for calculating angle of movement of the head.

According to some embodiments of the invention, wherein user's behavior is further identified by a calculation of a combination of tilting, head movement and pupils' movement, and wherein the pupils' movement is measured by a camera that is recording images of the pupils.

According to some embodiments of the invention, the identified event is a running application and the selecting of the partial area is according to parameters of the running application.

According to some embodiments of the invention, the identified event is a selection of an object in a live broadcast.

According to some embodiments of the invention, the selecting of the partial area in a map is based on position of a device in the real world as it is presented in the map according to Global Positioning System (GPS).

According to some embodiments of the invention, the visually enhancing of said AOI area is by having enlarged font size at the vertical center.

According to some embodiments of the invention, the degree of visual enhancement dynamically changes according to font size of the text.

According to some embodiments of the invention, objects in the AOI area are identified after sorting out other objects.

According to some embodiments of the invention, the AOI area includes application icons on a homepage of the computerized mobile device.

According to some embodiments of the invention, the dynamically changing of the display of the original image according to the AOI by visually enhancing said AOI area is applied on a keyboard area.

According to some embodiments of the invention, the scrolling is according to at least one of: (i) an identified orientation change; and (ii) movement of pupils of the user.

According to some embodiments of the invention, the scrolling of said AOI area in the original image is performed according to at least one of: (i) activity of the game application; and (ii) a touch of a user on the screen.
According to some embodiments of the invention, a system for changing display of an original image on a screen of a computerized mobile device is provided herein. The system comprising: an area of interest module, operable through a processor of said mobile device, configured for receiving data from said at least one sensor, selecting an area of interest over the screen by identifying presentation predefined conditions and dynamically selecting of a focal area inside said selected area of interest; and a convex module, operable through said processor and screen, for dynamically changing of the characters presentation over the screen by creating a curving optical visual effect according to the selected area of interest and presentation conditions, said curving visual effect includes visually enhancing the characters around a focal area, which is a selected part of the area of interest, and gradually reducing the enhancement visual effect in a continuous manner farther from the selected focal area, said enhancement includes at least one of the following: enlarging of the characters font size, adding characters, enlarging space between characters, or creating a focus effect at the focal area; and dynamically changing the focal area according to changing conditions that are deduced from data input by said sensor, wherein the visual enhancement creates a 3D visual effect in which the characters appear to be deployed over a curved surface.

According to some embodiments of the invention, a system for changing display of an original image on a screen of a computerized mobile device is provided herein. The system comprising: (i) a Area of interestArea of interest (AOI) module for:

(i) dynamically identifying conditions related to display changes, wherein the identified conditions are as a result of an identified event; (ii) dynamically selecting at least one area of the original image that is displayed on the screen that is defined as a Area of interest (AOI), according to the identified conditions; and (iii) dynamically changing the display of the original image according to the AOI by visually enhancing said AOI area such that the visual enhancement gradually decreases from the AOI and farther thereto, to visually emphasize the AOI area while maintaining visual continuity of the entire original image. The visually enhancing provides enlargement of the AOI area.

### BRIEF DESCRIPTION OF THE DRAWINGS

The present invention will be more readily understood from the detailed description of embodiments thereof made in conjunction with the accompanying drawings of which:

FIG. 1A is an exemplary diagram, illustrating a regular screen of a computerized mobile device in viewing mode, according to some embodiments of the invention;

FIG. 1B is an exemplary diagram, illustrating a screen of a computerized mobile device in viewing mode and convex mode presented in the center, according to some embodiments of the invention;

FIG. 1C is an exemplary diagram, illustrating a screen of a computerized mobile device in viewing mode and visual enhancement area is presented on the left-side, according to some embodiments of the invention;

FIG. 1D is an exemplary diagram, illustrating a screen of a computerized mobile device in viewing mode and a visual enhancement area is presented on the right-side, according to some embodiments of the invention;

FIG. 2 is an exemplary diagram illustrating a screen of a computerized mobile device with visual enhancement area, according to some embodiments of the invention;

FIG. 3A is an exemplary diagram illustrating a screen of a computerized mobile device in writing mode and with no visual enhancement area, according to some embodiments of the invention;

FIG. 3B is an exemplary diagram illustrating a screen of a computerized mobile device in writing mode and with a visual enhancement area presented on the center, according to some embodiments of the invention;

FIG. 3C is an exemplary diagram illustrating a screen of a computerized mobile device in writing mode and with a visual enhancement area presented on the left-side, according to some embodiments of the invention;

FIG. 3D is an exemplary diagram illustrating a screen of a computerized mobile device in writing mode and with a visual enhancement area presented on the right-side, according to some embodiments of the invention;

FIG. 3E is an exemplary diagram illustrating a screen of a computerized mobile device in writing mode and with no visual enhancement area, where the letters on the keyboard are organized by statistics of usage, according to some embodiments of the invention;

FIG. 3F is an exemplary diagram illustrating a screen of a computerized mobile device in writing mode and with visual enhancement area presented on the center, where the letters on the keyboard are organized by statistics of usage, according to some embodiments of the invention;

FIG. 3G is an exemplary diagram illustrating a screen of a computerized mobile device in writing mode and with visual enhancement area presented on the left-side, where the letters on the keyboard are organized by statistics of usage, according to some embodiments of the invention;

FIG. 3H is an exemplary diagram illustrating a screen of a computerized mobile device in writing mode and with visual enhancement area presented on the right-side, where the letters on the keyboard are organized by statistics of usage, according to some embodiments of the invention;

FIG. 3I is an exemplary diagram illustrating a screen of a computerized mobile device in writing mode and with visual enhancement area presented on the right-side, where the letters on the keyboard are organized by statistics of usage, according to some embodiments of the invention;

FIG. 3J is an exemplary diagram illustrating a screen of a computerized mobile device in writing mode and no visual enhancement area, where the letters on the keyboard are organized by statistics of usage, according to some embodiments of the invention;

FIG. 3K is an exemplary diagram illustrating a screen of a computerized mobile device in writing mode and with visual enhancement area presented on the left-side, where the letters on the keyboard are organized by statistics of usage, according to some embodiments of the invention;

FIG. 3L is an exemplary diagram illustrating a screen of a computerized mobile device in writing mode and with visual enhancement area presented on the center, where the letters on the keyboard are organized by statistics of usage, according to some embodiments of the invention;

FIG. 4 is a block diagram, illustrating modules for operation of visual enhancement application, according to some embodiments of the invention;

FIG. 5 is a flowchart diagram, illustrating activity of display module, according to some embodiments of the invention;

FIG. 6 is a flowchart diagram, illustrating activity of visual enhancement module, according to some embodiments of the invention;

FIGS. 7A-7B is a flowchart diagram, illustrating activity of orientation module, according to some embodiments of the invention;

FIG. 8 is a flowchart diagram, illustrating activity of learning module, according to some embodiments of the invention;

FIG. 9 is a flowchart diagram, illustrating activity of training module, according to some embodiments of the invention;

FIG. 10 is a flowchart diagram, illustrating activity of keyboard module, according to some embodiments of the invention;

FIG. 11 is an exemplary diagram, illustrating homepage of the computerized mobile device displayed in convex mode, according to some embodiments of the invention;

FIGS. 12A-12F are exemplary diagrams, illustrating optional forms and shapes of curved and polygonal display on a screen of a computerized mobile device, where there is change in density in areas in the original image according to some embodiments of the invention;

FIG. 13 is an exemplary diagram illustrating a user's finger sliding on a screen of a computerized mobile device to initiate a visual enhancement area, according to some embodiments of the invention;

FIGS. 14A and 14B are exemplary diagrams, illustrating a display of a geographic map on a screen of a computerized mobile device, according to some embodiments of the invention;

FIG. 15 is an exemplary diagram, illustrating one or more areas in focus on the screen of the computerized mobile device, according to some embodiments of the invention;

FIG. 16 is an exemplary diagram, illustrating different shape of curve to represent the areas in focus on the screen of the computerized mobile device, according to some embodiments of the invention;

FIG. 17 is an exemplary diagram, illustrating different shape of curve to represent the areas in focus on the screen of the computerized mobile device, according to some embodiments of the invention;

FIG. 18A is an exemplary diagram, illustrating two displays of an application game “Angry birds” 1805A and 1815A with no visual enhancement area and a display 1810 which is a combination of the two displays 1805A and 1815A;

FIG. 18B is an exemplary diagram, illustrating three displays of an application game “Angry birds” 1805B, 1810B and 1815B with visual enhancement area, where the AOI is on the left, right and center respectively;

FIGS. 19A and 19B are an exemplary diagram of magnifying maps according to prior art.

FIG. 20 is an exemplary diagram illustrating a screen of a computerized mobile device in normal viewing mode, according to some embodiments of the invention;

FIG. 21 is an exemplary diagram illustrating a screen of a computerized mobile device with visual enhancement area in horizontal orientation with added text, according to some embodiments of the invention; and

FIG. 22 is an exemplary diagram illustrating a screen of a computerized mobile device with visual enhancement area in vertical orientation with added text, according to some embodiments of the invention.

FIG. 23 is a flowchart, schematically illustrating a method for dynamically displaying characters over a display area of a screen of a mobile device, according to some embodiments of the invention.

### DETAILED DESCRIPTION OF SOME EMBODIMENTS OF THE INVENTION

Before explaining at least one embodiment of the invention in details, it is to be understood that the invention is not limited in its application to the details of construction and the arrangement of the components set forth in the following description or illustrated in the drawings. The invention is applicable to other embodiments and/or may be practiced or carried out in various ways. Also, it is to be understood that the phraseology and terminology employed herein is for the purpose of description and should not be regarded as limiting.

The present invention, in some embodiments thereof, provides a system and a method for dynamically displaying characters over a display area of a screen of a mobile device, using one or more sensors of the mobile device that can be used to identify, for example, holding orientation of the device and angular positioning thereof in respect to the user's head. In some embodiments, the method includes selecting an area of interest over the screen according to presentation conditions; dynamically changing presentation of the characters over the screen by creating a curving optical visual effect over the selected area of interest according to the presentation conditions and a focal area of the area of interest; and dynamically changing the position of the focal area inside the area of interest according to data from the sensor(s).

The visual enhancement creates a 3D visual effect in which the characters appear to be deployed over a curved surface. To achieve this effect the characters' presentation is enhanced the closer they are to the focal area within the area of interest. For example, the enhancement includes enlarging characters' font size, enlarging space between characters, changing the coloration and/or resolution (focus) of the characters and the like.

According to some embodiments, the characters presented may be textual content or in case of a touch screen, an image of a virtual keyboard presenting the alphabet, punctuation signs and/or numeric signs. The focal area is dynamically changed in response to the position of the area of interest due to sensed changes in the positioning/orientation of the mobile device in relation to the positioning of the user's head or hand for allowing the visual effect to follow the focusing of the user's gaze (e.g. when reading textual content) and/or typing orientation (e.g. when typing over the virtual keyboard).

The term “viewing mode” as used herein in this application, is defined as: (i) a mode of reading text; (ii) a mode of watching a game application; (iii) a mode of watching a geographic map; and (iv) a live broadcast.

The term “areas of change in density in the original image” as used herein in this application, is defined as one or more changes of density in a display on a screen of a computerized mobile device.

The term “visual enhancement” as used herein in this application, includes: (i) a convex mode which is one or more convex visual effect of display on a screen of the computerized mobile device and the visual enhancement area is curved; (ii) a polygon visual effect in which the visual enhancement is polygonal; and (iii) change in density (or resolution) in the original image or sharpness of the image. Optionally, the one or more visual enhancement areas allow a display of an image with a larger amount of data than the same display image with no visual enhancement.

The term “Area of interest (AOI)” as used herein in this application, is defined as a partial area in an image that is displayed on a screen of a computerized mobile device, in which the user has potential interest. The area is specified with different design characteristics than the design characteristics of other areas of the image.

The term “event” as used herein in this application, is defined as an occurrence or happening which triggers identification of conditions related to display changes. For example, an event may be a running application, user behavior, movement of a device which appears on a geographic map application or a selection of an object in a live broadcast.

According to some embodiments of the invention, conditions related to display changes of an original image may be identified. The identified conditions are as a result of an identified event. Design changes, such as visual enhancement may be applied on the original image for creating one or more areas of change in density in the original image. The design changes are dynamically applied according to the AOI. The applying of design changes result in change of density in the display of the original image on the screen. Optionally, the change in density may enlarge the partial area of the original image that is defined as AOI and may decrease areas which are not defined as AOI in the screen.

According to some embodiments of the invention, degree of design changes is determined by the user. In a non-limiting example, an original image may be text. Objects in the selected AOI may be identified after sorting out other objects.

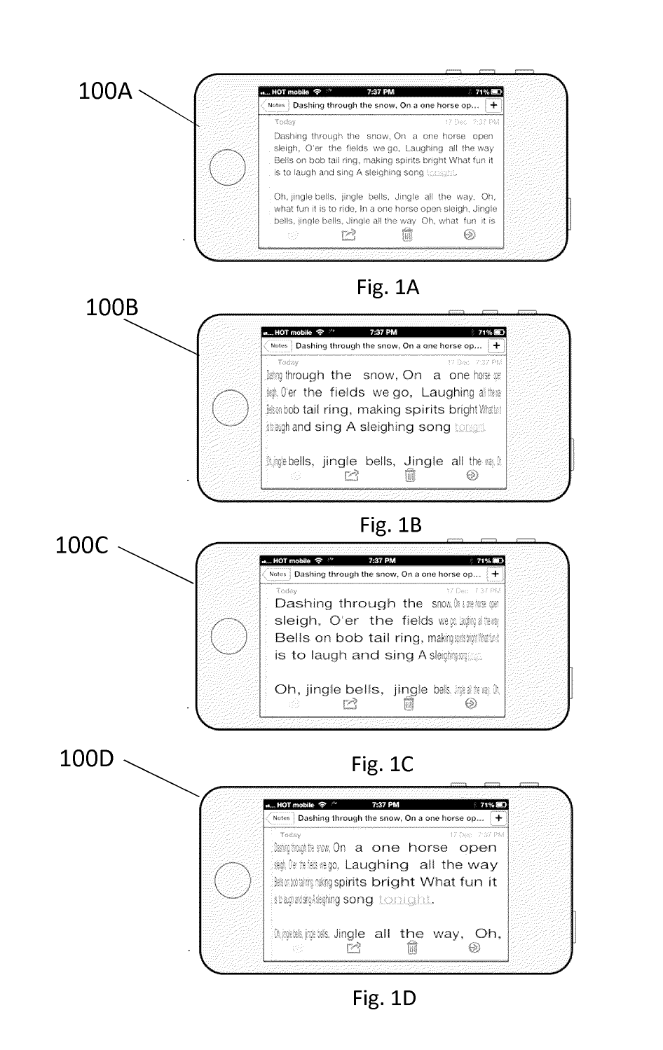

FIG. 1A is an exemplary diagram, illustrating a regular screen of a computerized mobile device in a viewing mode 100A, according to some embodiments of the invention. The screen of the computerized mobile device 100A is in viewing mode and displays text.

FIG. 1B is an exemplary diagram, illustrating a screen of a computerized mobile device in viewing mode and with visual enhancement area 100B, according to some embodiments of the invention.

According to some embodiments of the present invention, when a computerized mobile device is in a regular viewing mode 100A as in FIG. 1A, a user may switch the display of text on the screen to a convex mode.

As illustrated in FIG. 1B the original image is a display of text on the screen 100B when it is switched to central visual enhancement area, Area of interest (AOI) (i.e. an area in the screen) which was dynamically selected may be in an enlarged size font in the center of the screen and gradually the size of font is reduced in the text that is out of center i.e. not in AOI. Additionally, the displayed text may have increased letter-spacing between characters in the middle of the screen i.e. in the area which is AOI compared to the displayed text in out of center. The letter-spacing between characters is gradually reduced from the center to the out of center area to maintain visual continuity of the entire original image.

According to some embodiments of the present invention, a user may scroll horizontally or vertically the visual enhancement area on the screen of a computerized mobile device by: (i) tilting the device; (ii) recognizing movement of user's pupils and acting accordingly, i.e. scrolling the convex area in the direction of the user's pupils movement.

Furthermore, there may be a defined gesture for the user to add visual enhancement area and to get out of visual enhancement area. According to some embodiments of the present invention, the defined gesture for the user to add visual enhancement area and to get out of visual enhancement area may be movement of gaze.

According to some embodiments of the invention, a user may be allowed to define a max size of font that the user would like to be displayed with. In case a text is presented in that size of font (i.e. the defined max size) than no extra enhancement will be made.

FIG. 1C is an exemplary diagram, illustrating a screen 100C of a computerized mobile device in viewing mode and left-side of the screen with visual enhancement area i.e. the area which is AOI is on the left side, according to some embodiments of the invention. When a user wishes to read the text on the left side of the screen, upon a predefined gesture the left side may be enlarged in a convex, polygonal or change of density manner.

FIG. 1D is an exemplary diagram, illustrating a screen 100D of a computerized mobile device in viewing mode and right-side of the screen is with visual enhancement area i.e. the area which was selected as AOI is on the right side, according to some embodiments of the invention. When a user wishes to read the text on the right side of the screen, upon a predefined gesture the right side may be enlarged in a convex, polygonal or change of density manner.

According to some embodiments of the present invention, instead of shifting the visual enhancement area between the left side, the right side and the center of the screen, the visual enhancement area remains in the center of the screen and the text may be scrolled horizontally or vertically.

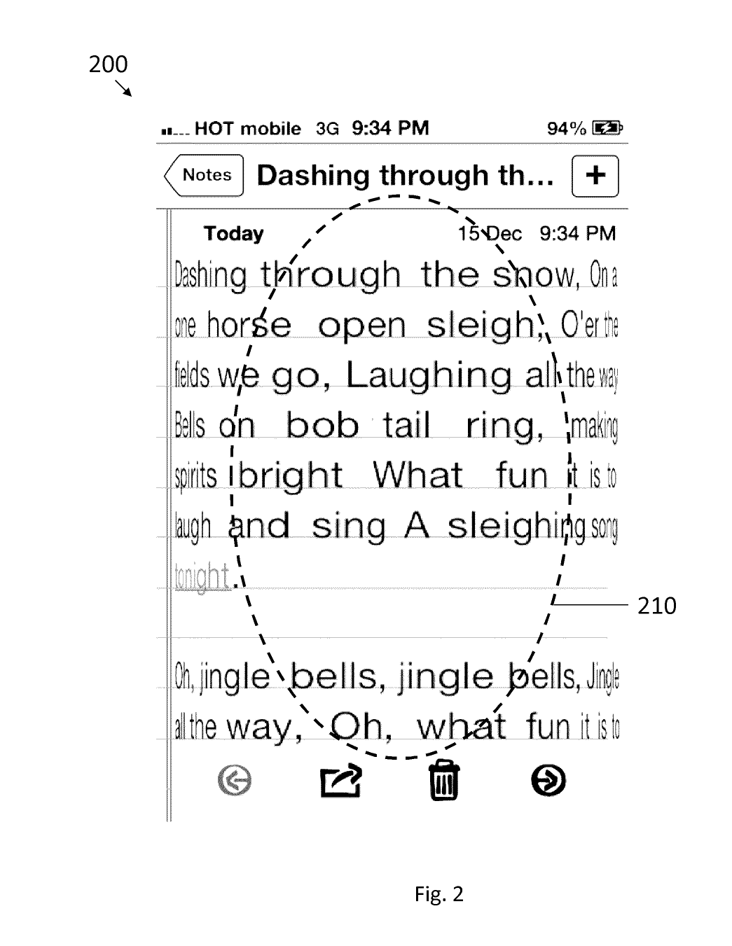

FIG. 2 is an exemplary diagram illustrating a screen 200 of a computerized mobile device that has a display area displaying text or an image thereover (e.g. an image of a keyboard or any other image) operated according to some embodiments of the invention. The screen shot 200 shows an exemplary moment in which the application has selected an area of interest (AOI) 210 over the screen 200 according to predefined conditions such as according to holding orientation of the mobile device marking input through touch screen thereof, a middle area of the text display area and the like and operated a visual effect module thereof for changing a focus of the AOI 210 applied over the AOI of part thereof in which the text appears to be deployed over a concave screen even though the screen is flat by enlarging the font of the letters in the focal area and spacing there between (I.e. in this case a focal axis) and gradually reducing the spacing and the font size of the letter the farther they are from that focal area (e.g. axis).

According to some embodiments of the present invention, the font size in the area of interest 210 is gradually enlarged until reaching the center of the area of interest 210 and letter-spacing between characters is increased gradually toward the middle i.e. the area of interest 200 having a AOI is in the middle of the screen 200, creates an illusion of a convex display of the screen across the vertical center of the screen, of the computerized mobile device.

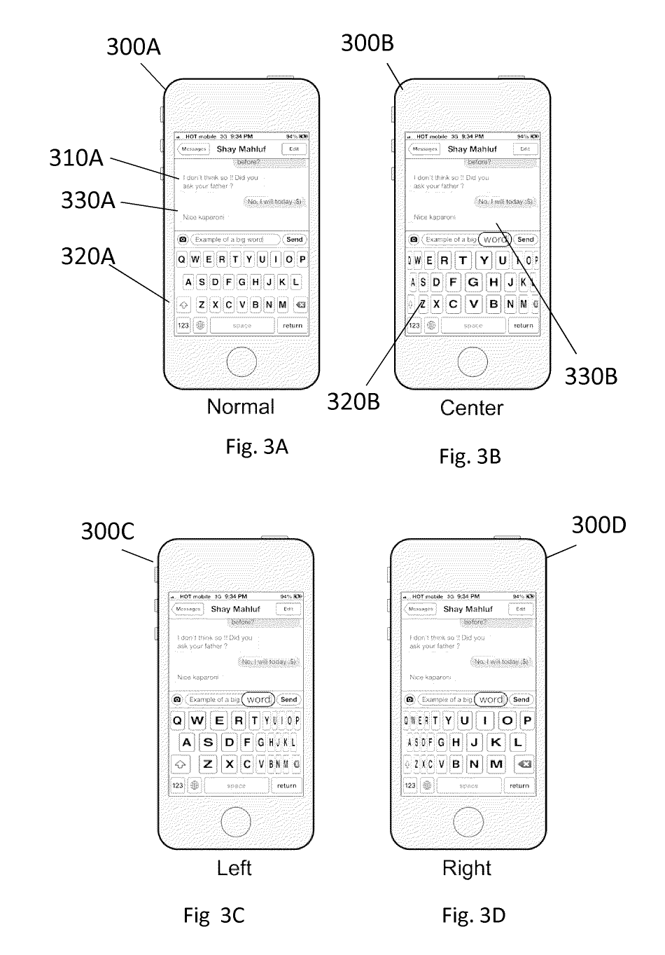

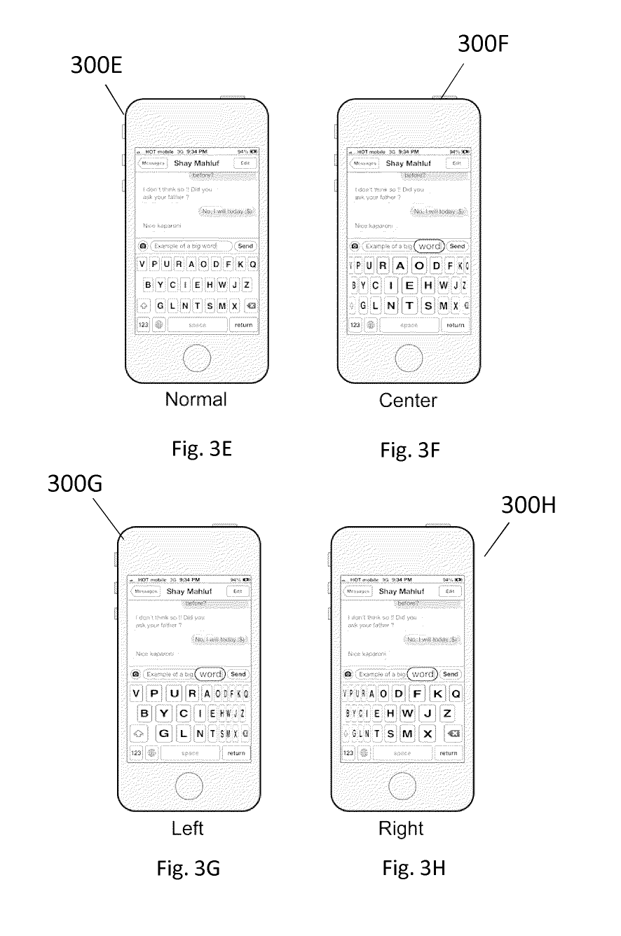

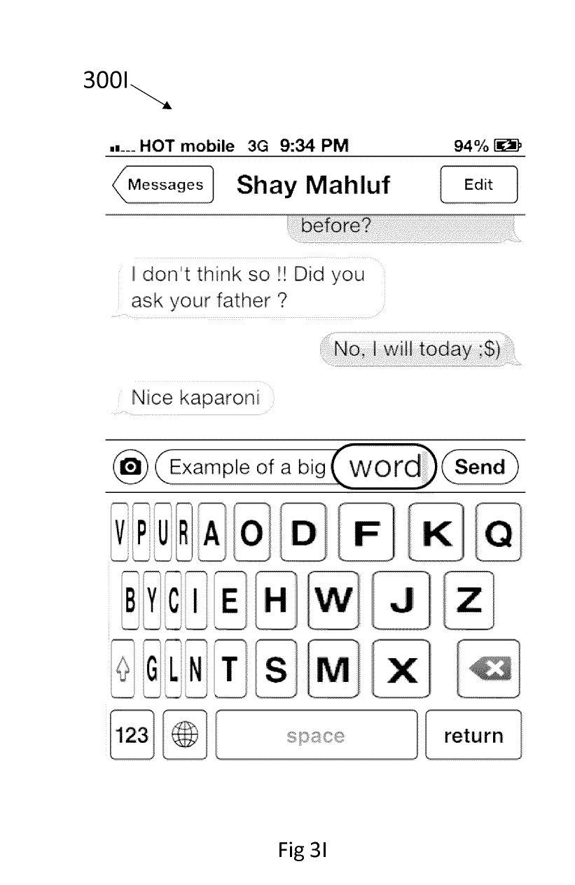

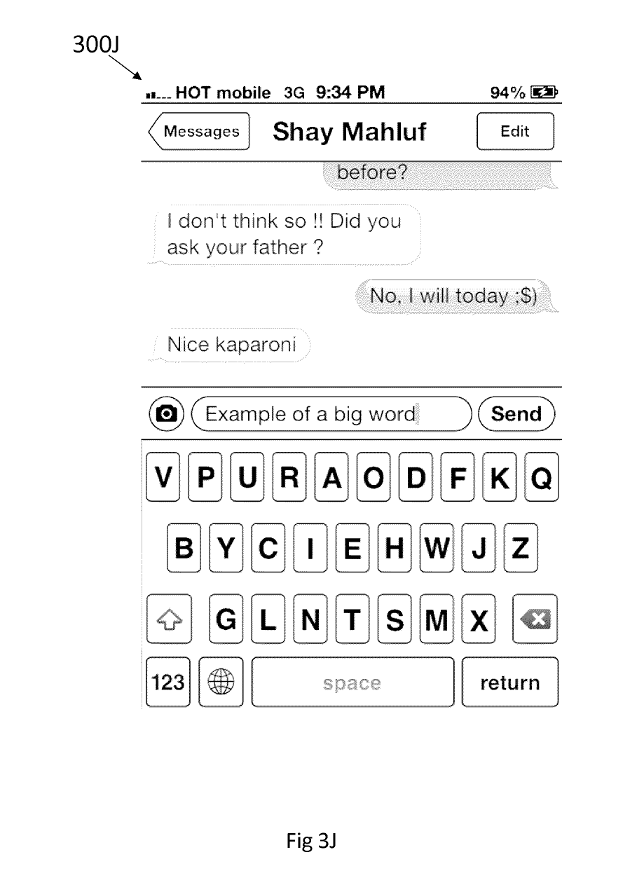

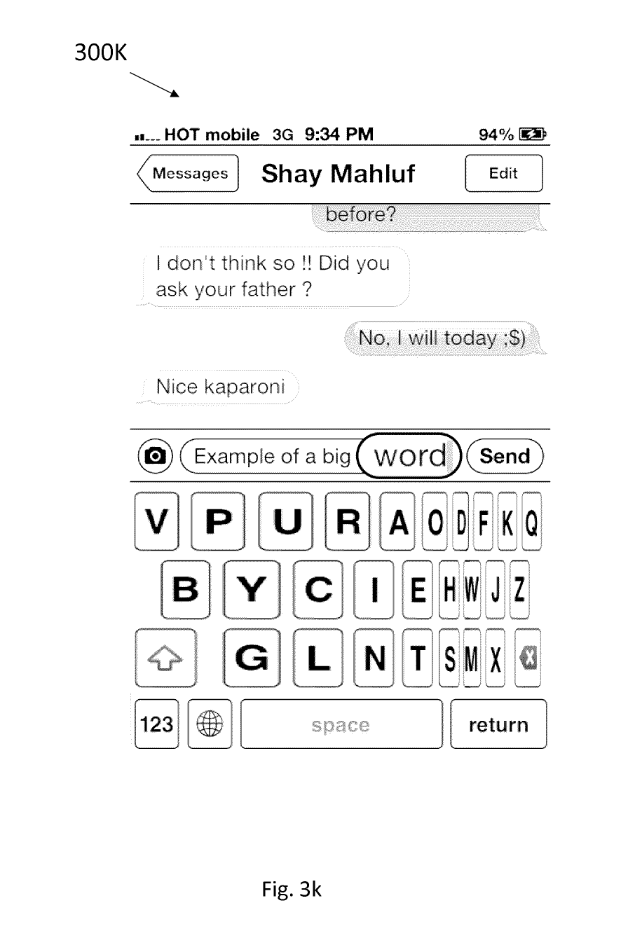

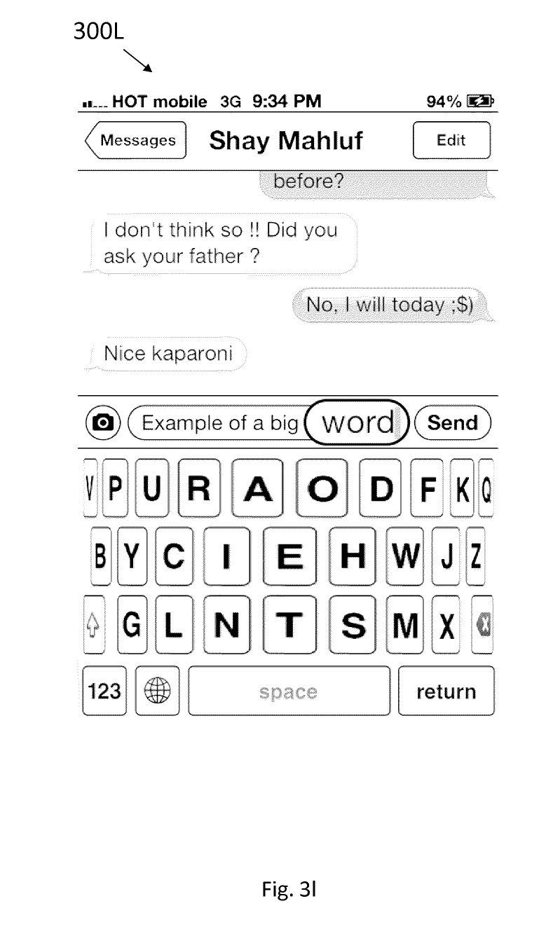

FIG. 3A is an exemplary diagram illustrating a screen 300A of a computerized mobile device in writing mode with no visual enhancement area, according to some embodiments of the invention.

According to some embodiments of the invention, a larger amount of data than the same display image that is with no visual enhancement area may be displayed. Meaning, with visual enhancement area, there may be more letters presented in the keyboard area than in regular mode.

According to some embodiments of the present invention, in writing mode when, convex mode if turned off, the letters which are displayed in the keyboard area 320A are all in the same size. Also, in a pane 330A, which displays the words which are being typed, the letters are in the same size. The pane 310A above pane 330A displays the text that was typed.

FIG. 3B is an exemplary diagram illustrating a screen 300B of a computerized mobile device in writing mode and in central convex mode i.e. the area which is AOI is in the center of the screen, according to some embodiments of the invention.

According to some embodiments of the present invention, in writing mode and convex mode turned on i.e. design changes may be applied on AOI area, the letters which are displayed in the keyboard area 320B are not in the same size. The letters in the center of the keyboard area 320B are enlarged gradually toward the middle of the screen, compared to letters which are out of the center of the keyboard area. Also, in a pane 330B, which displays the words that are being typed, the letters of the words that are currently typed are enlarged compared to letters of words that were previously typed.

FIG. 3C is an exemplary diagram illustrating a screen 300C of a computerized mobile device in writing mode and with visual enhancement area on the left-side, according to some embodiments of the invention. When a user wishes to use letters which are located on the left side of the keyboard i.e. the area which is AOI is on the left side, upon a predefined gesture the left side may be enlarged in a convex, polygonal or change of density manner.

FIG. 3D is an exemplary diagram illustrating a screen 300D of a computerized mobile device in writing mode and with visual enhancement area on the right-side, according to some embodiments of the invention. When a user wishes to use letters which are located on the right side of the keyboard i.e. the area which is AOI is on the right side, upon a predefined gesture the left side may be enlarged in a convex, polygonal or change of density manner. According to some embodiments of the invention, the letters with higher rate of usability i.e. the AOI is according to rate of usability may be presented in the center and the letters with lower rate of usability may be presented on the sides.

FIG. 3E is an exemplary diagram illustrating a screen 300E of a computerized mobile device in writing mode with no visual enhancement area, where the letters on the keyboard are organized by statistics of usage, according to some embodiments of the invention.

FIG. 3F is an exemplary diagram illustrating a screen 300F of a computerized mobile device in writing mode and with visual enhancement area presented on the center, where the letters on the keyboard are organized by statistics of usage, i.e. objects which are statistically in higher interest to the user may be displayed in the center of the screen which is the AOI area, according to some embodiments of the invention.

FIG. 3G is an exemplary diagram illustrating a screen 300G of a computerized mobile device in writing mode and convex mode presented on the left-side, where the letters on the keyboard are organized by statistics of usage, i.e. objects which are statistically in higher interest to the user may be displayed on the left side of the screen which is the AOI area, according to some embodiments of the invention.

FIG. 3H is an exemplary diagram illustrating a screen 300H of a computerized mobile device in writing mode and with visual enhancement area presented on the right-side, where the letters on the keyboard are organized by statistics of usage i.e. objects which are statistically in higher interest to the user may be displayed on the right side of the screen which is the AOI area, according to some embodiments of the invention.

FIG. 3I is an exemplary diagram illustrating a screen 300I of a computerized mobile device in writing mode and convex mode presented on the right-side, where the letters on the keyboard are organized by statistics of usage, according to some embodiments of the invention.

FIG. 3J is an exemplary diagram illustrating a screen of a computerized mobile device in writing mode and with no visual enhancement area, where the letters on the keyboard are organized by statistics of usage, according to some embodiments of the invention.

FIG. 3K is an exemplary diagram illustrating a screen of a computerized mobile device in writing mode and with visual enhancement area presented on the left-side, where the letters on the keyboard are organized by statistics of usage, according to some embodiments of the invention.

FIG. 3L is an exemplary diagram illustrating a screen of a computerized mobile device in writing mode and with visual enhancement area presented on the center, where the letters on the keyboard are organized by statistics of usage, according to some embodiments of the invention

According to some embodiments of the invention, the visual enhancement area may remain in the center of the keyboard i.e. area of AOI and the text may scroll horizontally or vertically.

According to some embodiments of the invention, the visual enhancement area may remain in the center of the pane and the text may scroll horizontally or vertically.

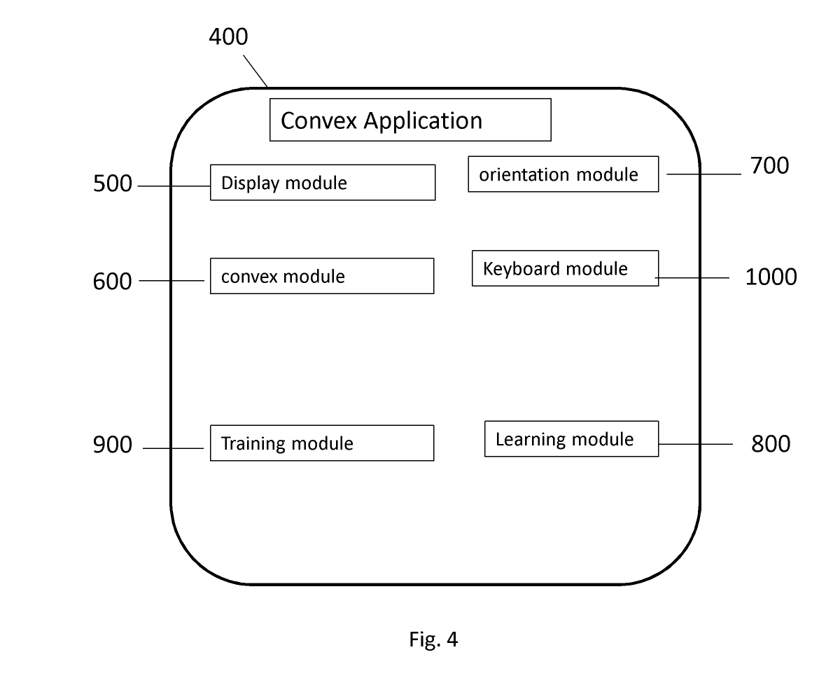

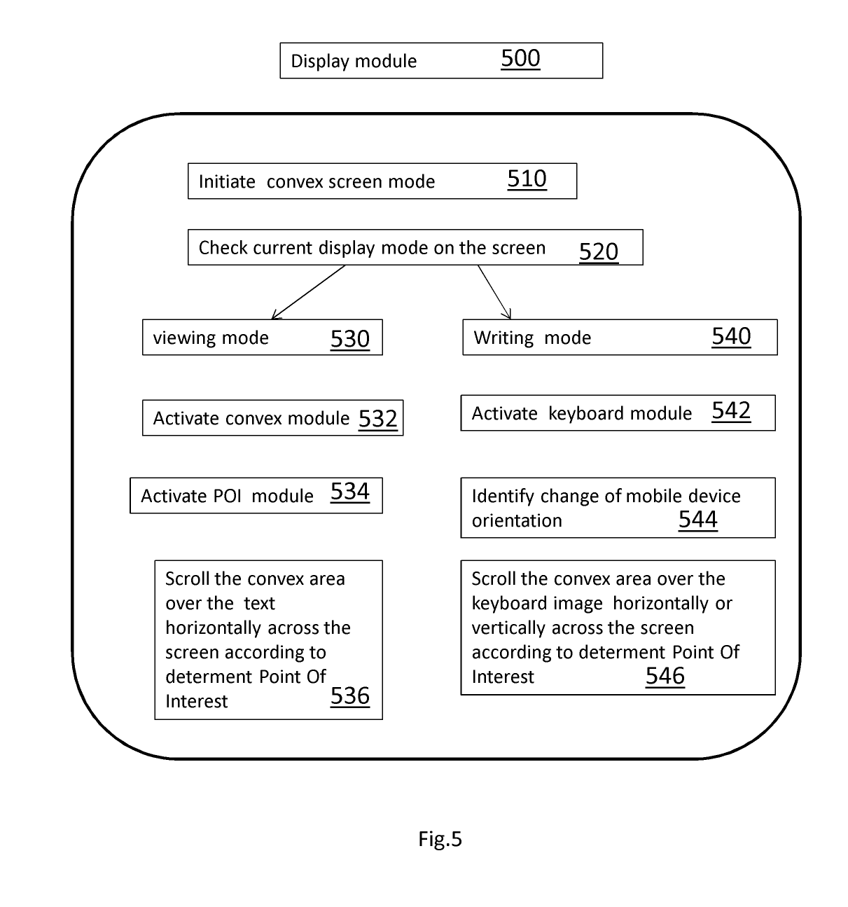

FIG. 4 is a block diagram, illustrating modules for operation of visual enhancement application 400 in a computerized mobile device, according to some embodiments of the invention.

The application 400 can be implemented as: (i) an independent application of a Smartphone; (ii) an integrated part of the operating system of the Smartphone; and (iii) a utility which can be provided for application developers to be integrated with their application.

According to some embodiments of the invention, a display module 500 may operate visual enhancement area on a screen of a computerized mobile device for viewing mode and writing mode as illustrated in detail in FIG. 5.

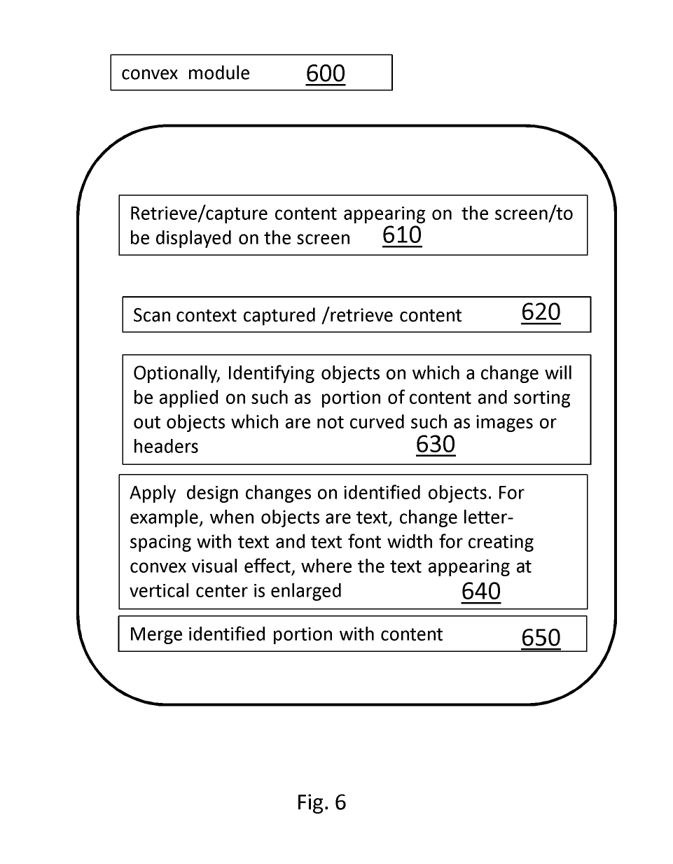

According to some embodiments of the invention, a visual enhancement module 600 may implement visual enhancement area in viewing mode of an area which is AOI that is displayed on a screen of a computerized device as illustrated in detail in FIG. 6.

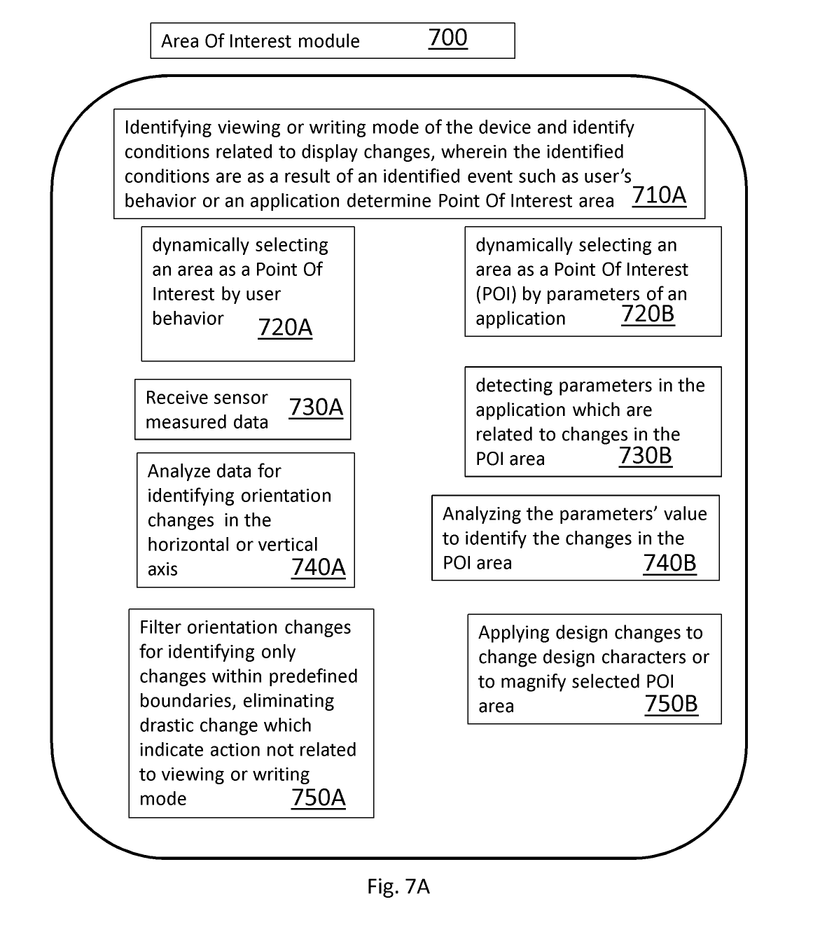

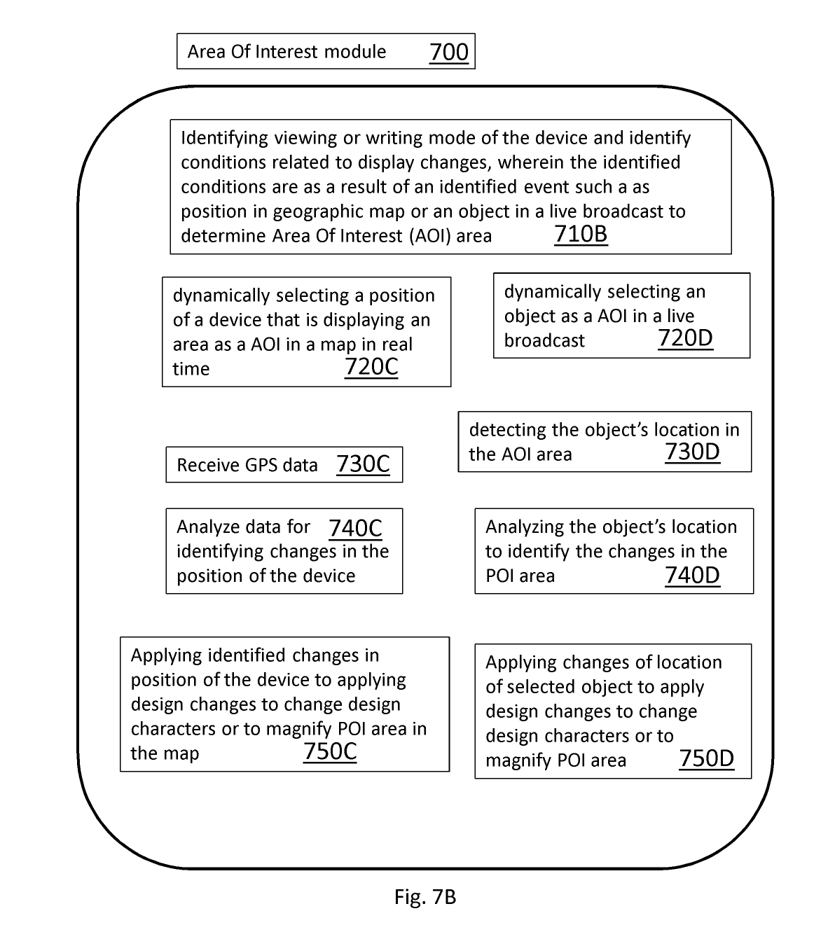

According to some embodiments of the invention, AOI module 700 for identifying desirable mode of display as illustrated in detail in FIG. 7.

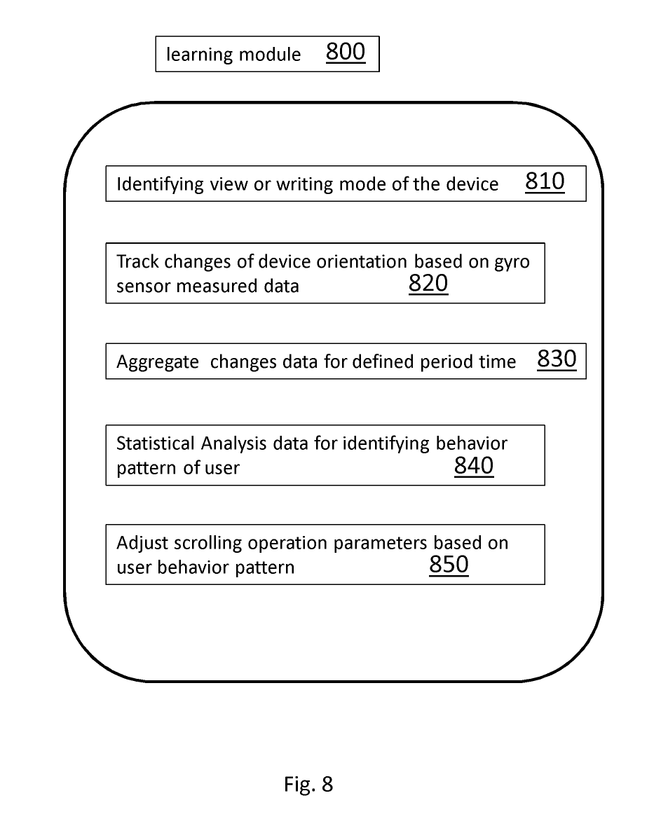

According to some embodiments of the invention, learning module 800 for accumulating information related to desired mode of display of a user as illustrated in detail in FIG. 8.

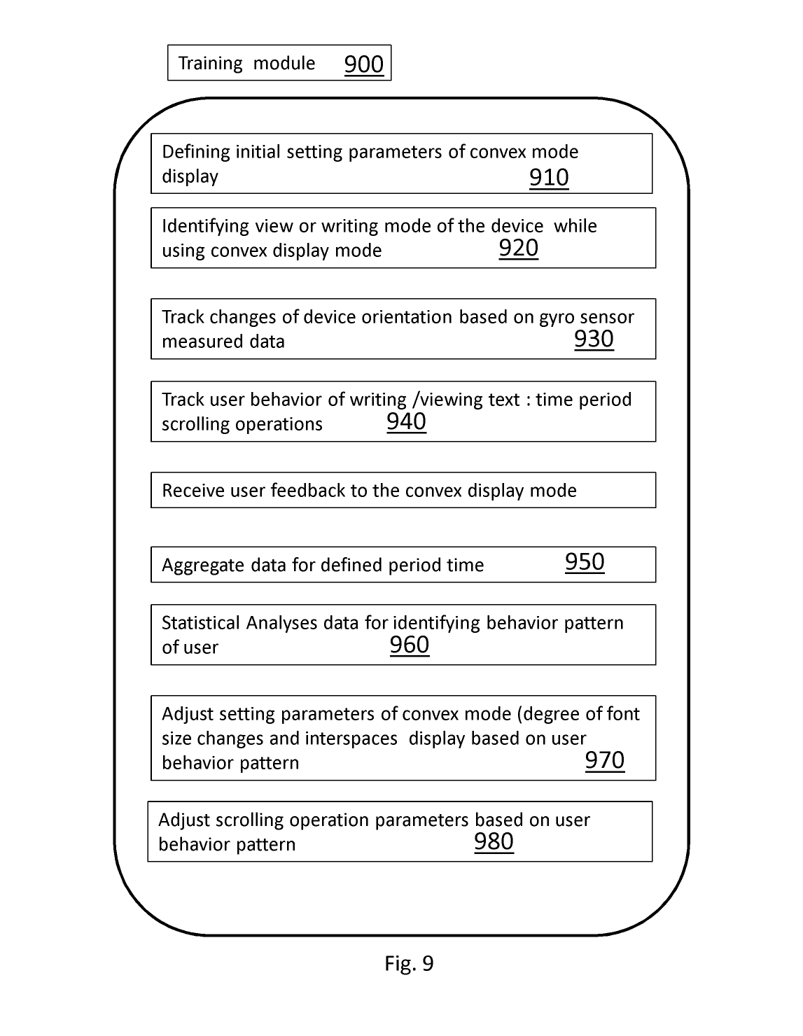

According to some embodiments of the invention, training module 900 for a gradual transition visual enhancement area as illustrated in detail in FIG. 9. Meaning, a gradual increase in the curve of the area which is AOI or the slope of the polygonal shape. For example, increase of letters in the center of the display and a gradual increase in letter-spacing.

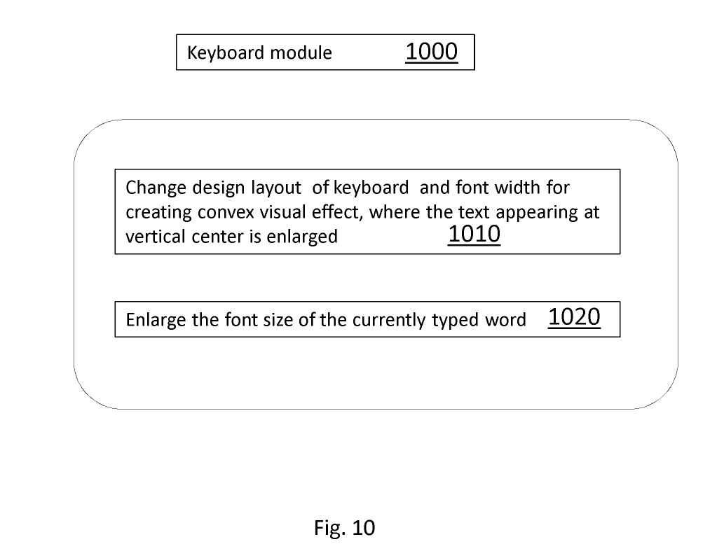

According to some embodiments of the invention, keyboard module 1000 for implementing convex mode in keyboard area as illustrated in detail in FIG. 10.

FIG. 5 is a flowchart diagram, illustrating activity of display module 500, according to some embodiments of the invention.

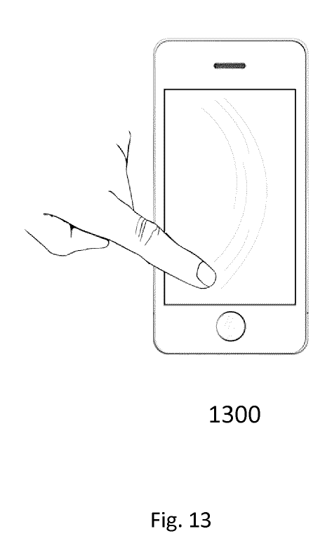

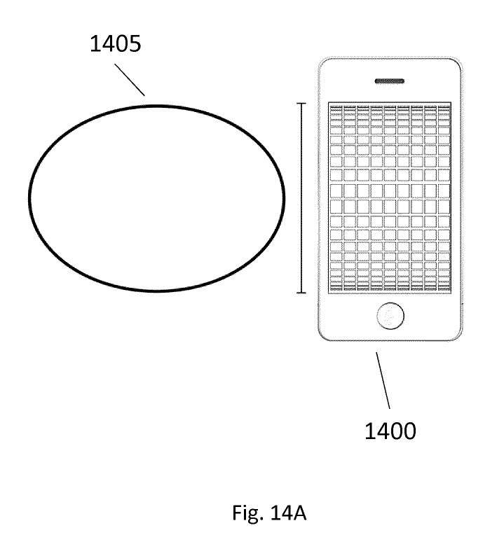

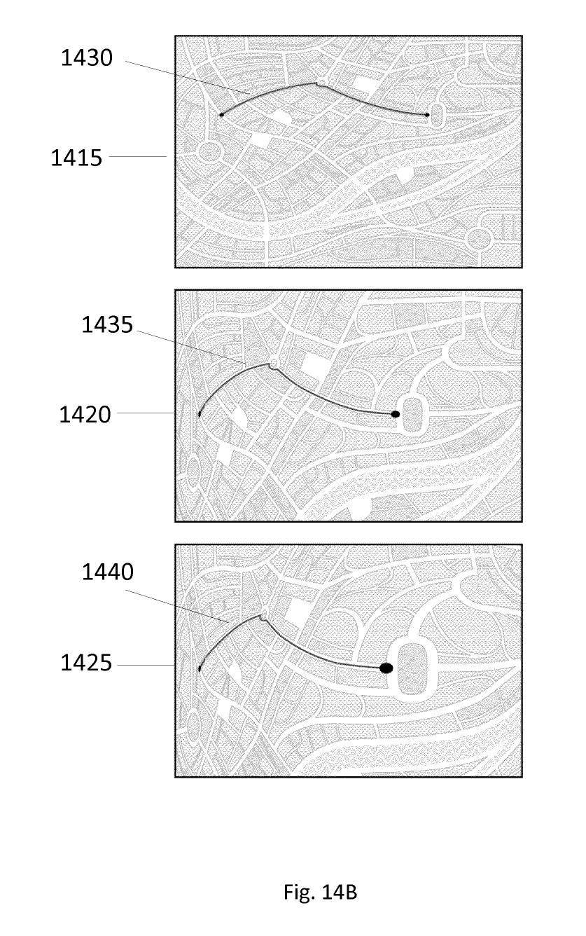

In a non-limiting example, the AOI is text. According to some embodiments of the invention, display module 500 may initiate a visual enhancement mode after identifying a predefined gesture that is performed by a user, such as horizontal tilt (and optionally vertical tilt for scrolling the text up and down) (stage 510) or by identifying head gazing direction orientation of the user. Another example to initiate a convex screen mode is by the user's slide of finger on the screen in a certain direction or slide of the user's finger to draw a certain form on the screen as illustrated in FIG. 13. The display module 500 may check current display mode on the screen of the computerized mobile device (stage 520). For example, in case no keyboard is presented the display module 500 may infer that the screen is in usage in viewing mode.

According to some embodiments of the invention, in case a writing mode was identified (stage 540) keyboard module 1000 is being activated (stage 542). Next, when a change in horizontal orientation or vertical orientation of the computerized mobile device is identifying (stage 544) the convex area on the keyboard display is scrolled horizontally or vertically across the screen according to identified orientation change (stage 546).

According to some embodiments of the invention, in case a viewing mode is identified (stage 530) display module 500 may activate convex text module 600. Next, display module 500 may activate the AOI module 700 (step 534).

According to some embodiments of the invention, when partial area of the screen is dynamically selected as AOI, the visual enhancement area over the text is scrolled (stage 536), enlarging other parts of the text while maintaining visual continuity of the entire text.

FIG. 6 is a flowchart diagram, illustrating activity of convex module 600, according to some embodiments of the invention.

According to some embodiments of the invention, when visual enhancement module 600 is activated by display module 500 it may retrieve content that is displayed on the screen of the computerized mobile device (stage 610). Next, convex module 600 may scan the retrieved content (stage 620) to identify images and objects within the images on which a change will be applied such as text portion of the content and to sort out objects that the change will not be applied on (i.e. will not be enhanced) such as images or headers in text (stage 630) since the content of images may include objects such as images or headers which are not curved. Next, design changes may be applied on the identified images and objects and leaving out objects that were sorted out.

The design changes in case the images are text may include: (i) gradual change of letter-spacing between characters in the text; and (ii) gradually enlarging the font size of letters that are displayed toward the center to create convex or polygonal visual effect such that the text displayed in vertical center is enlarged while maintaining visual continuity of the entire text. (stage 640). The radius of the curve in the convex visual effect or the angle in polygonal visual effect may change according to user's selection or dynamically according to the font size of letters.

According to some embodiments of the invention, visual enhancement module 600 may merge changes that were performed on the identified portion with the rest of the content (stage 650).

According to some embodiments of the invention, visual enhancement module 600 may be activated when game applications are running and displayed on the computerized mobile device.

According to some embodiments of the invention, visual enhancement module 600 may be activated on geographic maps which are displayed on a screen of a computerized mobile device, as illustrated in details in FIG. 14.

FIG. 7A is a flowchart diagram, illustrating activity of Area of interest module 700, according to some embodiments of the invention.

According to some embodiments of the invention, Area of interest module 700 may identify viewing mode or writing mode of the display screen of the computerized mobile device and may identify conditions related to display changes, wherein the identified conditions are as a result of an identified event such as user behavior or an application determine Area of interest area (stage 710A).

According to some embodiments of the invention, user's behavior is identified by a calculation of a combination of: (i) tilting of the computerized mobile device; and (ii) head movement, wherein a gyroscope sensor is measuring the tilting, and wherein a camera is recording images of a head of the user for calculating angle of movement of the head.

Additionally, user's behavior may be identified by a calculation of a combination of: tilting of the computerized mobile device and head movement in combination with pupils' movement and the pupils' movement may be calculated by a camera that is recording images of the pupils.

Next, dynamically selecting AOI by identifying an area as an AOI by user behavior. User behavior may be at least one of: (i) tilting of the computerized mobile device; (ii) pupils movement; and (iii) head movement (stage 720A) or identifying as area as an AOI by parameters of an application (stage 720B).

According to some embodiments of the invention, in case the identified AOI was by user behavior after receiving measured data from a sensor on the computerized mobile device (stage 730A) the area of interest module 700 may analyze the data for identifying orientation changes in horizontal or vertical axis (stage 740A). The sensor may be of various types such as gyroscope sensor, accelerator sensor, tilting sensor, camera and/or a compass.

According to some embodiments of the invention, orientation changes may be filtered to identify only changes within boundaries. Thus, eliminating drastic change such as, in a non-limiting example, when a user puts the computerized mobile device in a pocket, meaning an action that does not indicate of viewing mode or writing mode (stage 750A). Motion in other axis may be examined to eliminate non-relevant actions.

According to some embodiments of the invention, accelerator sensor may be checked to eliminate an option in which the user using the computerized mobile device in a viewing mode.

According to some embodiments of the invention, in case the identifying of the area as an AOI is performed by parameters of an application (stage 720B) parameters of the application which are related to changes in the AOI may be detected (Stage 730B). The parameters of the application may be parameters related to objects' position in the image in the application game and to background of the application game.

The value of the parameters may be analyzed to identify changes in the AOI area (Stage 740B). Applying design changes to change design characters or to magnify AOI area (stage 750B).

FIG. 7B is a flowchart diagram, illustrating activity of Area of interest module 700, according to some embodiments of the invention.

According to some embodiments of the invention, Area of interest module 700 may identify viewing mode or writing mode of the display screen of the computerized mobile device and identify conditions related to display changes, wherein the identified conditions are as a result of an identified event such as a position of a device in the real world which is presented in a geographic map or a an object in live broadcast to determine Area of interest area (stage 710B). Next, dynamically selecting a position of a device that is displaying an area as an AOI in a map in real time (stage 720C) or dynamically selecting an object as an AOI in a live broadcast (stage 720D).

According to some embodiments of the invention, in case the identified AOI was performed by a position of a device, identifying Global Positioning System (GPS) data (stage 730A) the Area of interest module 700 may analyze the data for identifying orientation changes in the position of the device (stage 740C).

According to some embodiments of the invention, applying the identified changes in position of the device to apply design changes to change design characters or to magnify AOI area in the map (stage 750C).

According to some embodiments of the invention, in case the identifying of the area as an AOI is by a dynamic selection of an object as an AOI presented in a live broadcast (stage 720D) location of the object in the AOI area may be detected (Stage 730D). The location of the object in the live broadcast may be analyzed to identify the changes in the AOI area (Stage 740D). Applying changes of location of the selected object to apply design changes to change design characters or to magnify AOI area (stage 750D).

FIG. 8 is a flowchart diagram, illustrating activity of learning module 800, according to some embodiments of the invention.

In a non-limiting example, the AOI is text. According to some embodiments of the invention, learning module 800 may identify viewing or writing mode of the display screen of the computerized mobile device (stage 810). In order to accumulate information regarding the user, changes of device orientation are being tracked based on gyro sensor measured data (stage 820). The changes data is aggregated for a predefined period of time (stage 830). Next, generating statistical analysis data for identifying behavior pattern of the user (stage 840). Based on user behavior scrolling operation parameters are adjusted, such as scrolling speed, sensitivity parameter which represents the relation between the orientation change and scrolling change (stage 850).

FIG. 9 is a flowchart diagram, illustrating activity of a training module 900, according to some embodiments of the invention.

According to some embodiments of the invention, for gradual usage of visual enhancement area meaning, increase in the curve of the area which is AOI or change in the angle of polygonal, training module 900 may perform the following actions. Defining initial setting parameters of visual enhancement area display (stage 910). In case the display is text, activating display module 500 to identify viewing or writing mode of the screen display of the computerized mobile device (stage 920). Next, tracking changes of device orientation based on gyro sensor measured data (stage 930). In case the display is text, tracking user's behavior of writing and viewing text and aggregating related parameters such as time period, scrolling operations and the like.

According to some embodiments of the invention, training module 900 may receive feedback from user to the display with visual enhancement area (stage 950). Additionally, data regarding user's switching from visual enhancement area to regular mode may be tracked and aggregated.

According to some embodiments of the invention, the data may be aggregated for a predefined period of time (stage 960) to generate statistical analysis data to identify behavior pattern of the user (stage 970). Next, adjust setting parameters for visual enhancement area based on user's behavior (stage 980). Meaning, in case the display is text, adjust the degree of font size changes and the letter-spacing on the screen display of the computerized mobile device based on the user's behavior. Next, adjust scrolling operation parameters based on user behavior pattern (stage 990).

FIG. 10 is a flowchart diagram, illustrating activity of keyboard module 1000, according to some embodiments of the invention.

According to some embodiments of the invention, keyboard module 1000 may change design layout of keyboard and font size (width, or height or both) for creating visual enhancement effect, where the text that is gradually enlarged and the letter-spacing are gradually increased (stage 1010) toward the vertical center. Additionally, enlarging font size of the currently typed word and increasing letter-spacing (stage 1020). The radius of the curve of the letters on the keyboard may change according to user's selection or dynamically according to the font size of letters on the keyboard.

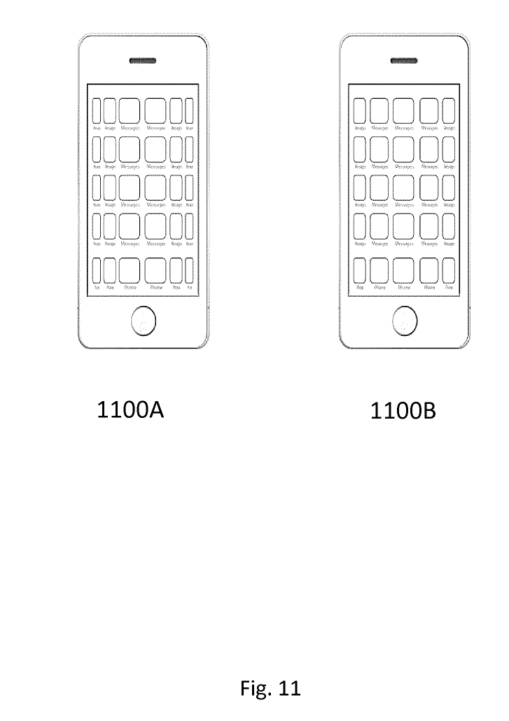

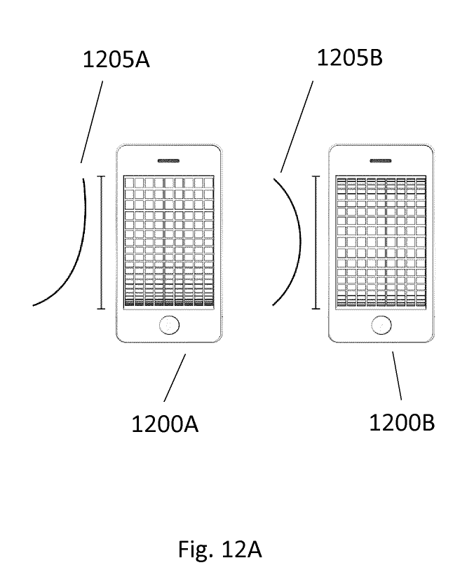

FIG. 11 is an exemplary diagram, illustrating homepage of the computerized mobile device displayed with a visual enhancement area, according to some embodiments of the invention.

According to some embodiments of the invention, a larger amount of data than the same display image that is without visual enhancement area may be presented to the user on the screen. Meaning, there may be more application icons presented on the homepage than before applying the visual enhancement area.

According to some embodiments of the invention, homepage of the computerized mobile device may have a visual enhancement area with a moderate curve as represented by element 1100A or visual enhancement area with excessive curve as represented by element 1100B. Optionally, the visual enhancement area may enable display of a greater amount of columns of icons of applications displayed in the homepage of the computerized mobile device. The visual enhancement area may be applied on an AOI area on the screen that displays the application icons while maintaining visual continuity of the entire original image.

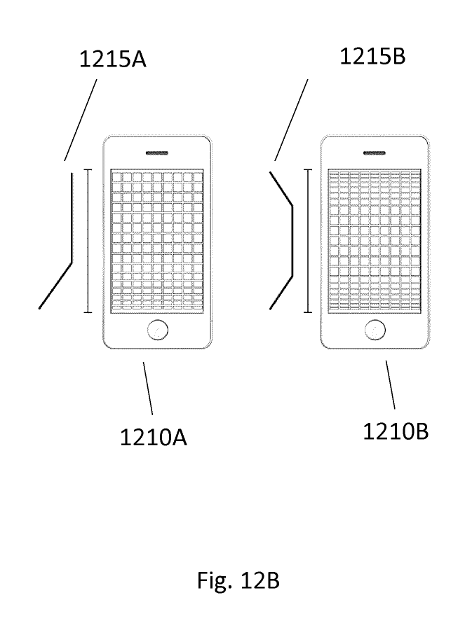

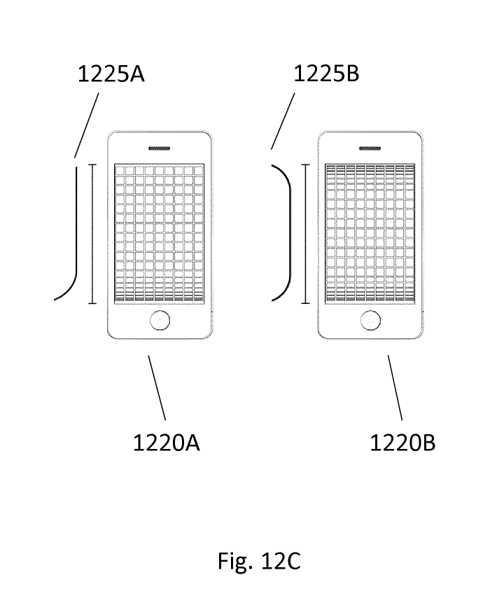

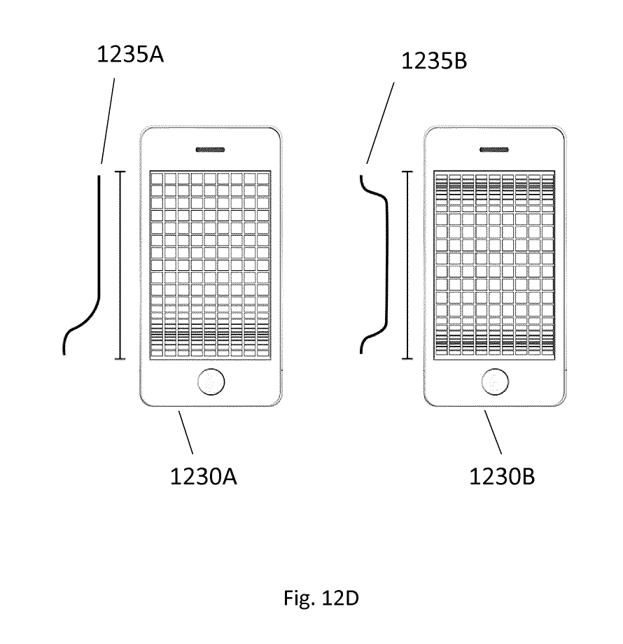

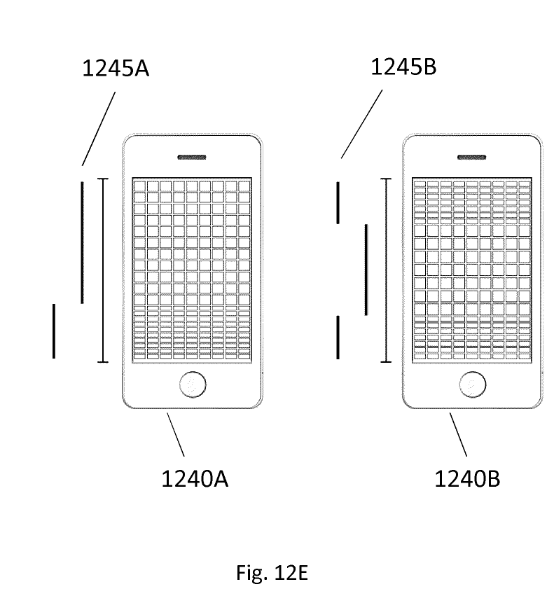

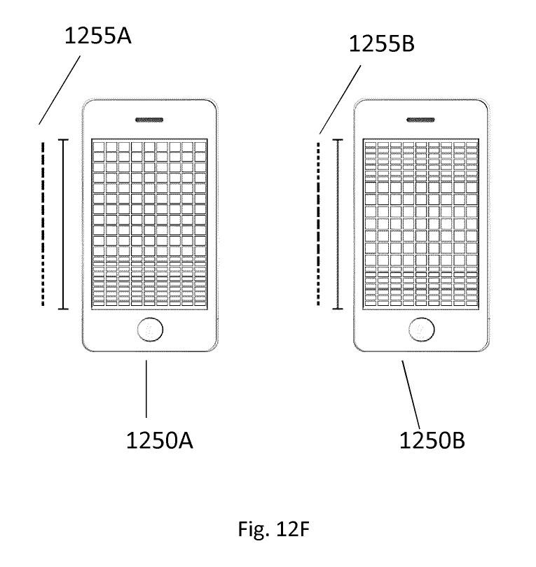

FIGS. 12A-12F are exemplary diagrams, illustrating optional forms and shapes of curved and polygonal display on a screen of a computerized mobile device, where there is change in density in areas in the original image according to some embodiments of the invention.

According to some embodiments of the invention, the radius of the curve of an area that is in focus may change according to user's selection.

FIG. 12A illustrates the angle of the curve as shown by element 1205A and 1205B and the screen may be displayed as shown by elements 1200A and 1200B.

FIG. 12B illustrates another example of an angle of the polygonal shape as shown by element 1215A and 1215B and the screen may be displayed as shown by elements 1210A and 1210B.

FIG. 12C illustrates another example of a different angle of the curve as shown by element 1225A and 1225B and the screen may be displayed as shown by elements 1220A and 1220B.

FIG. 12D illustrates another example of a different angle of the curve as shown by element 1235A and 1235B and the screen may be displayed as shown by elements 1230A and 1230B.

FIG. 12E illustrates different locations of areas on the screen where the AOI (i.e. focus) may be presented. The AOI areas are shown by elements 1245A and 1245B and the screen may be displayed as shown by elements 1240A and 1240B. According to this example the change between the different areas is not gradual and no convex effect is applied.

FIG. 12F illustrates example of gradual change of the visual enhancement as shown by elements 1255A and 1255B and the screen may be displayed as shown by elements 1250A and 1250B.

FIG. 13 is an exemplary diagram illustrating a user's finger sliding on a screen of a computerized mobile device to initiate a visual enhancement area, according to some embodiments of the invention.

According to some embodiments of the invention, the focus area i.e. AOI area on the screen of the computerized mobile device 1300 may be in areas where the user touches the screen.

FIG. 14A is an exemplary diagram, illustrating a display of a geographic map on a screen of a computerized mobile device, according to some embodiments of the invention.

According to some embodiments of the invention, a geographic map may be displayed with a visual enhancement area while maintaining visual continuity of the entire geographic map. A specific area in the map e.g. 1430 may be in focus, i.e. curved such as 1435 or 1440. For example, a user that is planning a trip to the Pyrenees may wish to have a closer look at the area of small towns on the Spanish side but may also wish to see the French side and the border with the Basque country on the west.

According to some embodiments of the invention, optionally, the selecting of the partial area (i.e. AOI) in a geographic map may be according to an event which is the position of a device that is displaying the map according to Global Positioning System (GPS) in real time. The position of the device may change as the device moves and accordingly the AOI in the map.

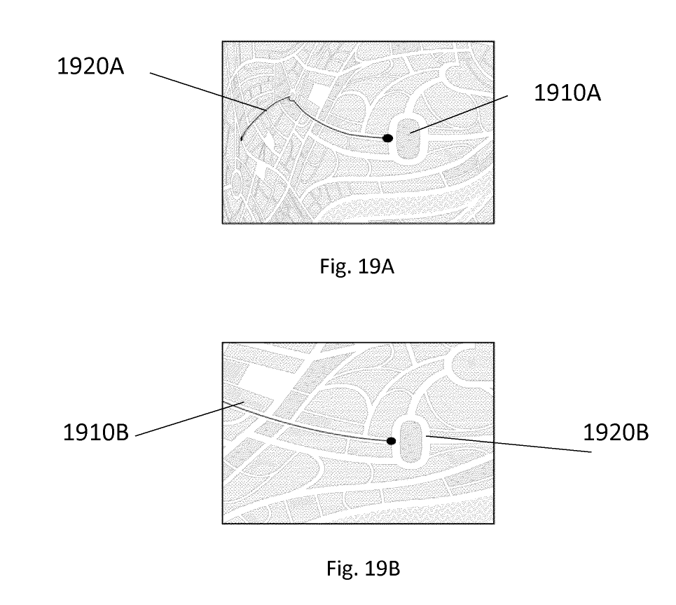

In prior art maps magnifying techniques as illustrated in FIGS. 19A and 19B, when magnifying the AOI 1920 part of the information is lost, in FIG. 19B part of the route 1910 is missing.

FIG. 14B is an exemplary diagram, illustrating a display of a geographic map on a screen of a computerized mobile device, according to some embodiments of the invention.

According to some embodiments of the invention, element 1415 may be a display of a geographic map. The geographic map 1415 may include an AOI area 1430 which is in focus as represented by element 1420. The AOI area 1430 in element 1415 may be enlarged even more, meaning, the angle of the curve or polygonal of the area that is in focus may be sharper 1440 as represented in element 1425.

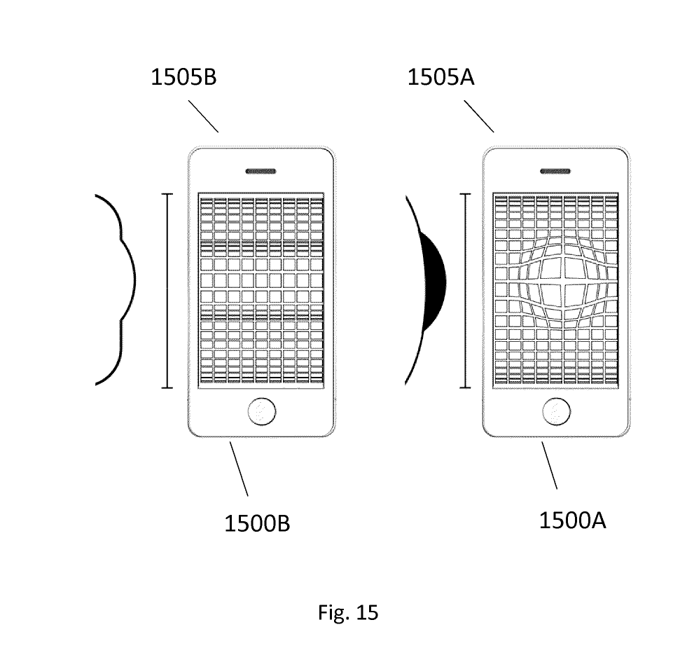

FIG. 15 is an exemplary diagram, illustrating one or more areas in focus on the screen of the computerized mobile device, according to some embodiments of the invention. Element 1500A is an example of a display of a screen of a computerized mobile device with one area in focus. The shape of the curve of the area in focus is represented by element 1505A.

According to some embodiments of the invention, two areas or more may be chosen to be with visual enhancement. Element 1500B represents three areas displayed in focus on the screen of the computerized mobile device. The shape of the curve is represented by element 1505B.

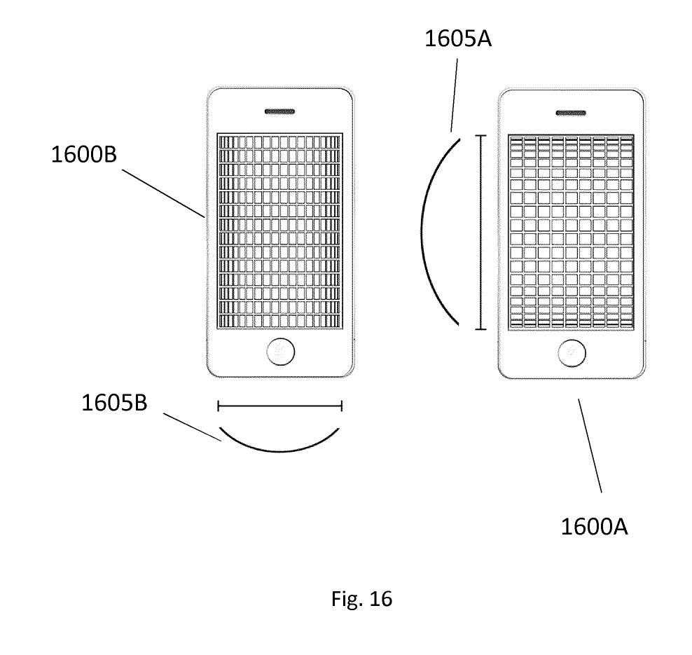

FIG. 16 is an exemplary diagram, illustrating different shape of curve to represent the areas in focus on the screen of the computerized mobile device, according to some embodiments of the invention.

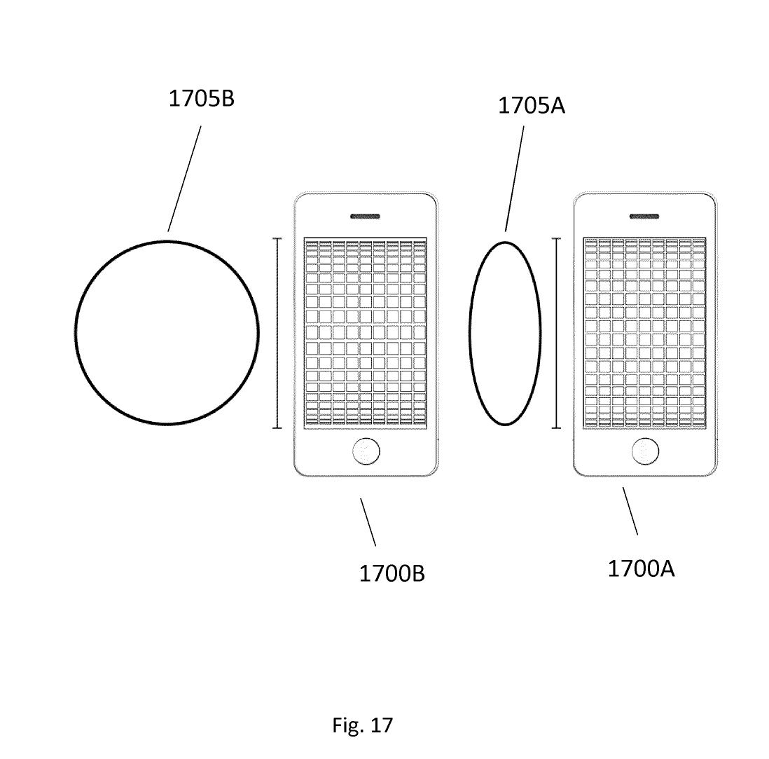

FIG. 17 is an exemplary diagram, illustrating different shape of curve to represent the areas in focus on the screen of the computerized mobile device, according to some embodiments of the invention.

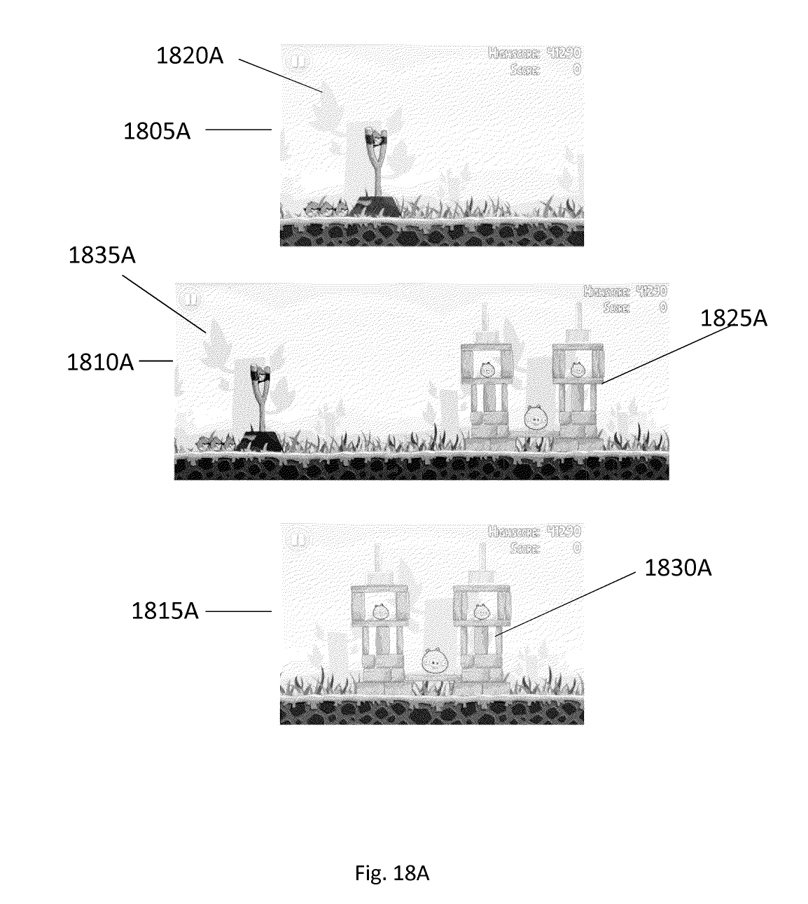

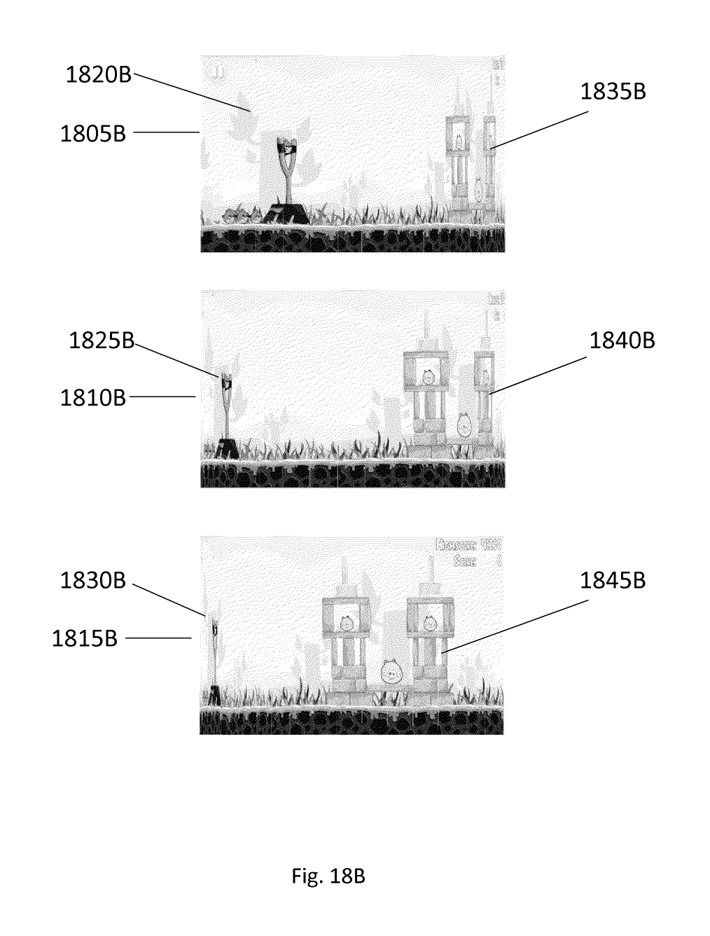

FIG. 18A is an exemplary diagram, illustrating two displays of the application game “Angry birds” 1805A and 1815A which does not include an area with visual enhancement and a display 1810 which is a combination of the two displays 1805A and 1815A.

A display of the computerized mobile device 1810A is a combination of displays 1805A and 1815A of the application game Angry Birds. An object 1820A in element 1805A is also displayed 1835A in element 1810A. An object 1825A in element 1810A is also displayed as object 1830A in element 1815A.

FIG. 18B is an exemplary diagram, illustrating three displays of the application game “Angry birds” of element 1810A in FIG. 18A with visual enhancement area 1805B, 1810B and 1815B, where the AOI is on the left, right and center respectively.

According to some embodiments of the invention, element 1805B represents a display of element 1810A in FIG. 18A with visual enhancement area on the left side while maintaining visual continuity of the entire application game. In element 1805B object 1820B is in the AOI area and object 1835B is not in focus.

According to some embodiments of the invention, element 1810B represents a display of element 1810A in FIG. 18A with visual enhancement area on the right side. In element 1810B object 1840B which is on the right side of the display, is in the AOI area and object 1825B is not in focus.

According to some embodiments of the invention, element 1815B represents a display of element 1810A in FIG. 18A with visual enhancement area in the center while maintaining visual continuity of the entire application game. In element 1815B object 1845B is in the AOI area and object 1830B is not in focus.

According to some embodiments of the invention, the invention may be beneficial to visually impaired users.

According to some embodiments of the invention, the display of the screen may be simulated to a cylinder and the user may roll the display 360° degrees.

According to some embodiments of the invention, the magnification of part of the screen display does not cover the area which is not magnitude.

According to some embodiments of the invention, a larger amount of data than the same display image that does not include visual enhancement area. Meaning, when there is an area with visual enhancement, more area of the game application may be presented to the user than without it.

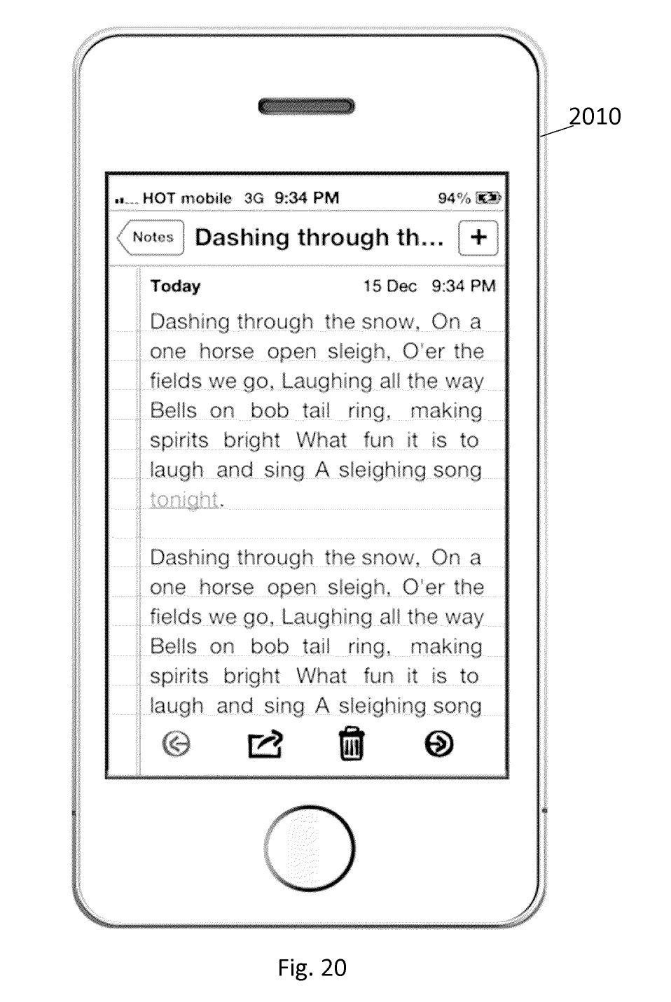

FIG. 20 is an exemplary diagram illustrating a screen 2010 of a computerized mobile device in normal viewing mode, according to some embodiments of the invention.

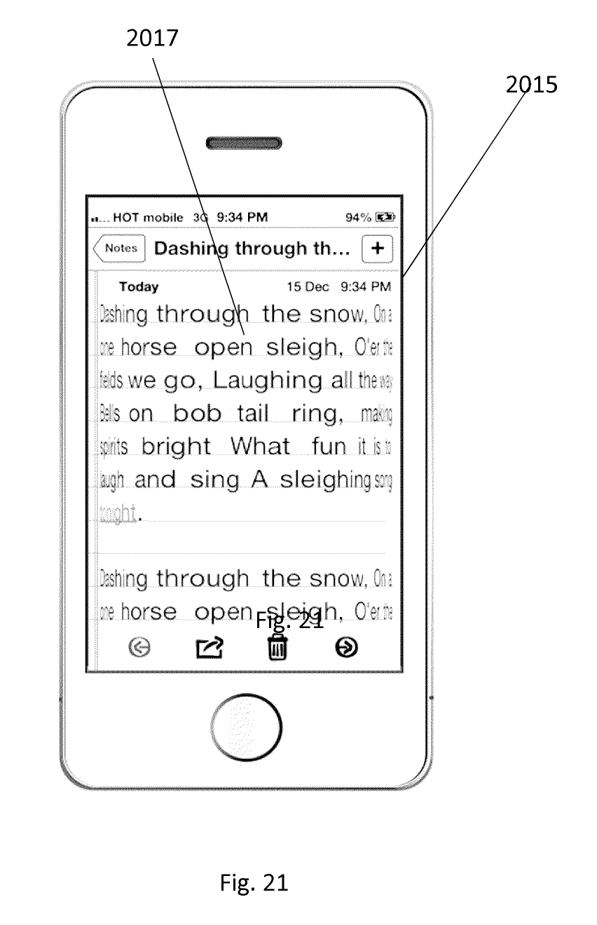

FIG. 21 is an exemplary diagram illustrating a screen 2015 of a computerized mobile device with visual enhancement area 2017 in horizontal orientation with enlarged text, according to some embodiments of the invention; and

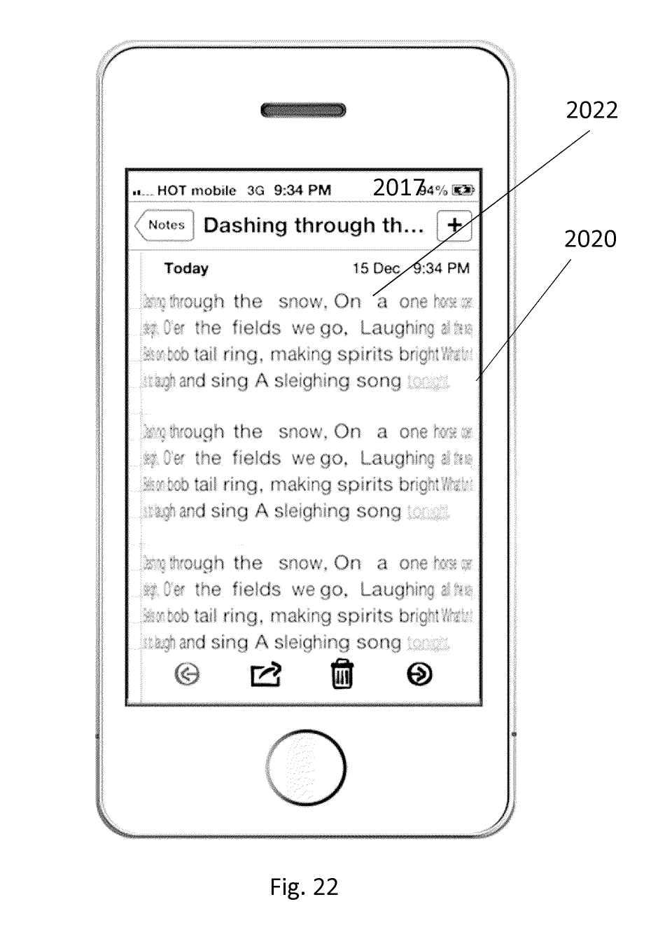

FIG. 22 is an exemplary diagram illustrating a screen 2020 of a computerized mobile device with visual enhancement area 2022 in vertical orientation with added text, according to some embodiments of the invention.

According to some embodiments of the invention, the screen of the computerized mobile device may be physically curved. The present invention may represent the content on the physically curved screen.

According to some embodiments of the invention, when an identified event is a running game application, the game application may be displayed with visual enhancement area the screen of the computerized mobile device may display the scene in the game and not part of it. The AOI that is the focus of the display i.e. the area in the screen that is curved may be according to the progress in the game application and the objects that are participating in the game application of the game. Meaning, in a non-limiting example, in Angry Birds application game, the focus may be, on a bird and a slingshot in a certain point of the game and then later on in another point in the game the focus may be on pigs. Optionally, the with visual enhancement area may enable display of a greater amount of area of the application game for the user including more objects which in regular mode were not displayed.

According to some embodiments of the invention, the focus (also referred to as “focal area”) may be determined by the application game. The application game controls the area of the game that is displayed on the screen therefore the application game may send information regarding the objects that should be in focus i.e. displayed in a curved polygonal or change of density manner.

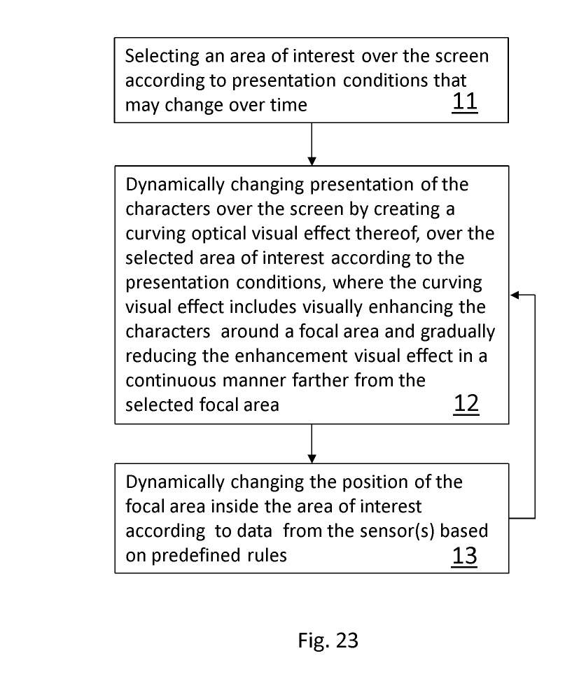

Reference is now made to FIG. 23, which is a flowchart schematically illustrating a method for displaying characters over a display area of a mobile device screen using at least one sensor. This method includes: (a) selecting of an area of interest over the screen according to presentation conditions 11; (b) dynamically changing presentation of the characters over the screen 12 by creating a curving optical visual effect thereof, over the selected area of interest according to the presentation conditions, where the curving visual effect includes visually enhancing the characters around a focal area, which is a selected part of the area of interest such as a focal point or axis, and gradually reducing the enhancement visual effect in a continuous manner farther from the selected focal area; and (c) dynamically changing the position of the focal area inside the area of interest according to data from the sensor 13. In this process the focal area as well as the area of interest can be changed over time and in real time due to changing conditions determining thereof such as changing of the orientation of the mobile device, input of touch points over the touch screen, changing of the image presented due to input from the user and the like.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for dynamically displaying characters over a display area of a mobile device screen using at least one sensor, said method comprising:
a) dynamically and continuously changing presentation of the characters over the whole screen by creating a curving optical visual effect thereof, over the whole screen, said curving visual effect includes visually enhancing the characters around a focal area, which is a selected part of the whole screen, and gradually reducing the enhancement visual effect in a continuous manner farther from the selected focal area, said enhancement includes at least one of the following: enlarging of the characters font size, adding characters, enlarging space between characters, or creating a focus effect at the focal area; and
b) dynamically and continuously changing the position of the focal area according to data from said at least one orientation sensor including acceleration sensor, gyro sensor, motion sensor or camera based on predefined rules,
wherein the visual enhancement creates a 3D visual effect in which the characters appear to be deployed over a curved surface, wherein the focal area is spread along a vertical area along the whole screen;
wherein the orientation of the characters presentation in relation to screen is unchanged;
wherein the selection of the area of interest, changing of the characters presentation, dynamically changing the focal area of the visual effect are carried out by at least one processor.

2. The method of claim 1, wherein the visual continuity in each area of visual enhancement in the original image is maintained by a polygonal visual effect.

3. The method of claim 1, wherein the visual enhancement includes: (i) change of resolution; and (ii) change of image sharpness.

4. The method of claim 1, wherein a convex visual effect enables display of a larger amount of data compared to the original image.

5. The method of claim 1, wherein the dynamically changing of the display of the original image according to the area of interest and focal area therein is carried out by enlarging font size and/or spacing between characters in a gradual continuous manner when approaching the focal area.

6. The method of claim 1 further comprising scrolling the area of visual enhancement in the original image horizontally or vertically across the screen of the computerized mobile device according to a change in a selected partial area displayed on the screen for viewing a different portion of the original image.

7. The method of claim 1 further comprising identifying user viewing orientation by a calculation of tilting of the computerized mobile device, wherein the at least one sensor comprises a gyroscope sensor for measuring the tilting of the device in relation to the gravitation vector.

8. The method of claim 7, wherein the user's viewing orientation is further identified by identification of tilting of the mobile device in combination with head movement of the user, said head movement is identified by analyzing image data arriving from a second camera sensor for stabilizing the display change, wherein the camera sensor is configured for capturing images of the head of the user and said identification comprises image analysis of images from said camera for calculating the movement of the head.

9. The method of claim 7, wherein the user viewing orientation is further identified by sensing user's finger motion on the screen using a touchscreen sensor for controlling the display change.

10. The method of claim 1, wherein the visually enhancing of said area of interest is by having enlarged font size at the vertical or horizontal center, wherein said focal area is a vertical or a horizontal axis.

11. The method of claim 1, wherein the degree of visual enhancement dynamically changes according to font size of the text.

12. The method of claim 5, further comprising the step dynamically identifying objects by predefined rules not related to sensor measurements at the AOI area and sorting out said objects from the visual curving effect.

13. The method of claim 1, wherein the characters displayed over the display area of the screen form a virtual keyboard.

14. A computerized mobile device for dynamically displaying an image over a display area said computerized mobile device screen, said mobile device having at least one motion sensor or camera and processor, said computerized mobile device processor comprising:
a) a convex module, operable through said processor and screen, for dynamically changing of a characters presentation over the screen by creating a curving optical visual effect of the whole screen, said curving visual effect includes visually enhancing the characters around a focal area, which is a selected part screen, and gradually reducing the enhancement visual effect in a continuous manner further from the selected focal area, said enhancement includes at least one of the following: enlarging of the characters font size, adding characters, enlarging space between characters, or creating a focus effect at the focal area and dynamically changing the focal area according to changing conditions that are deduced from data input by said motion sensor or camera, wherein the visual enhancement creates a 3D visual effect in which the characters appear to be deployed over a curved surface.
